(19) United States
(12) Patent Application Publication
(10) Pub. No.: US 2026/0358606 A1
(43) Pub. Date: Nov. 12, 2026

(54) OPTICAL SYSTEM, LENS MODULE, AND ELECTRONIC DEVICE

(71) Applicant: Jiangxi OFILM Optical Co.,Ltd., Nanchang (CN)

(72) Inventors: Kuo DING, Nanchang (CN); Binbin LIU, Nanchang (CN)

(73) Assignee: Jiangxi OFILM Optical Co.,Ltd., Nanchang (CN)

(21) Appl. No.: 19/654,421

(22) Filed: Apr. 21, 2026

(30) Foreign Application Priority Data
May 12, 2025 (CN) CN 202510607924.6

(51) Int. Cl. G02B 13/18; G02B 9/34; G02B 27/00

(52) U.S. Cl. CPC G02B 13/18; G02B 9/34; G02B 27/0081

(57) ABSTRACT

An optical system, a lens module, and an electronic device are provided. The optical system includes four lenses having refractive powers. The four lenses include, in order from an object side to an image side along an optical axis of the optical system: a first lens, having a negative refractive power, an object-side surface being concave proximal to circumference, and an image-side surface being convex proximal to the circumference; a second lens, having a refractive power; a third lens, having a positive refractive power, an object-side surface being convex proximal to the optical axis, and an image-side surface being concave proximal to the optical axis; a fourth lens, having a positive refractive power, an object-side surface being convex proximal to the optical axis, and an image-side surface being concave proximal to the optical axis. The optical system satisfies expressions: 0.9<FNO.

### CROSS-REFERENCE TO RELATED APPLICATION

This application claims priority to Chinese patent application No. 202510607924.6, filed on May 12, 2025, and titled “OPTICAL SYSTEM, LENS MODULE, AND ELECTRONIC DEVICE”. The content of the above identified application is hereby incorporated herein in its entirety by reference.

### TECHNICAL FIELD

The present disclosure relates to the technical field of optical imaging, and in particular, to an optical system, a lens module, and an electronic device.

### BACKGROUND

With the advancement of technology, especially in fields of computer vision and image processing, the demand for high-performance optical systems continues to grow. Time of Flight (ToF) optical systems are primarily used for depth perception and three-dimensional imaging, and are widely applied in fields such as autonomous driving, robotic navigation, virtual reality, and augmented reality. However, existing optical systems still suffer from a limited shooting range. Moreover, it is difficult to maintain compactness while achieving a larger field of view, and the relative illumination is relatively low. Consequently, the imaging quality under low-light conditions frequently fails to meet the requirements of modern applications. Therefore, it is particularly important to develop a lens assembly with a large aperture and a wide field of view.

### SUMMARY

The objective of the present disclosure is to provide an optical system, a lens module, and an electronic device, specifically a ToF optical system, which features a larger aperture, a wider field of view, and a higher image resolution.

To achieve the objective of the present disclosure, the following technical solutions are provided in the present disclosure.

According to a first aspect, an optical system is provided, including four lenses each having a refractive power. The four lenses include, in order from an object side to an image side along an optical axis of the optical system, a first lens, a second lens, a third lens, and a fourth lens. The first lens has a negative refractive power. An object-side surface of the first lens is configured as a concave surface proximal to a circumference of the first lens. An image-side surface of the first lens is configured as a convex surface proximal to the circumference of the first lens. The second lens has a refractive power. The third lens has a positive refractive power. An object-side surface of the third lens is configured as a convex surface proximal to the optical axis. An image-side surface of the third lens is configured as a concave surface proximal to the optical axis. The fourth lens has a positive refractive power. An object-side surface of the fourth lens is configured as a convex surface proximal to the optical axis. An image-side surface of the fourth lens is configured as a concave surface proximal to the optical axis.

In the optical system provided in the present disclosure, the high-quality imaging performance under low-light conditions can be achieved by matching the refractive powers of the four lenses. Specifically, the first lens has the negative refractive power, the object-side surface of the first lens is configured as the concave surface proximal to the circumference of the first lens, and the image-side surface of the first lens is configured as the convex surface proximal to the circumference of the first lens. This configuration facilitates the collection of incident rays over a wide field of view. In addition, the second lens has the refractive power, which helps correct aberrations introduced by the front lens. Furthermore, the third lens has the positive refractive power, the object-side surface of the third lens is configured as the convex surface proximal to the optical axis, and the image-side surface of the third lens is configured as the concave surface proximal to the optical axis. This configuration is beneficial for delaying the rays entering the system from the front-end lens, and delaying the angle of the rays. Moreover, the fourth lens has the positive refractive power, which helps correct the spherical aberration, coma, and distortion produced by the preceding lens group. The total length of the system can be shortened. Meanwhile, an emergence angle of the rays can be constrained, and rays over a large range can be incident to an imaging plane.

In an implementation, the optical system satisfies the following relational expressions: 0.9<FNO<1.3, and 1600<FOV<177°. FNO represents an F-number of the optical system, and FOV represents a maximum field of view of the optical system. When the aforementioned relational expressions are satisfied, it ensures that the optical system possesses the characteristic of a large pore size, allowing sufficient amount of incident light into the optical system and resulting in clearer captured images. Additionally, it enables the optical system to achieve a wide field of view (FOV), thereby expanding the shooting range. Furthermore, the optical system exhibits the features of high pixel count and high resolution.

In a second aspect, a lens module is further provided in the present disclosure. The lens module includes the optical system according to any one of the embodiments of the first aspect and a photosensitive chip disposed at the image side of the optical system.

In a third aspect, an electronic device is further provided in the present disclosure, including a housing and the lens module according to the second aspect. The lens module is disposed in the housing.

### BRIEF DESCRIPTION OF THE DRAWINGS

To more clearly illustrate the technical solutions in the embodiments of the present disclosure or in the related art, the accompanying drawings that need to be used in the description of the embodiments or the related art will be briefly described below. It is apparent that the drawings in the following description are only some embodiments of the present disclosure. For those skilled in the art, other drawings may also be derived from these drawings without creative efforts.

FIG. 1 is a schematic structural diagram of an optical system according to a first embodiment.

FIG. 2 is an aberration diagram of the optical system according to the first embodiment.

FIG. 3 is a schematic structural diagram of an optical system according to a second embodiment.

FIG. 4 is an aberration diagram of the optical system according to the second embodiment.

FIG. 5 is a schematic structural diagram of an optical system according to a third embodiment.

FIG. 6 is an aberration diagram of the optical system according to the third embodiment.

FIG. 7 is a schematic structural diagram of an optical system according to a fourth embodiment.

FIG. 8 is an aberration diagram of the optical system according to the fourth embodiment.

FIG. 9 is a schematic structural diagram of an optical system according to a fifth embodiment.

FIG. 10 is an aberration diagram of the optical system according to the fifth embodiment.

FIG. 11 is a schematic structural diagram of an optical system according to a sixth embodiment.

FIG. 12 is an aberration diagram of the optical system according to the sixth embodiment.

FIG. 13 is a schematic structural diagram of an optical system according to a seventh embodiment.

FIG. 14 is an aberration diagram of the optical system according to the seventh embodiment.

FIG. 15 is a schematic diagram of a lens module provided in an embodiment of the present disclosure.

FIG. 16 is a schematic structural diagram of an electronic device provided in an embodiment of the present disclosure.

### DETAILED DESCRIPTION

The technical solutions in the embodiments of the present disclosure will be clearly and completely described below with reference to the accompanying drawings in the embodiments of the present disclosure. It is apparent that the described embodiments are merely a part rather than all of the embodiments of the present disclosure. All other embodiments obtained by those skilled in the art based on the embodiments of the present disclosure without creative efforts fall within the protection scope of the present disclosure.

In a first aspect, an optical system is provided in the present disclosure, including four lens each having a refractive power. The four lenses include, in order from an object side to an image side along an optical axis of the optical system, a first lens, a second lens, a third lens, and a fourth lens. The first lens has a negative refractive power, an object-side surface of the first lens is configured as a concave surface proximal to a circumference of the first lens, and an image-side surface of the first lens is configured as a convex surface proximal to the circumference of the first lens. The second lens has a refractive power. The third lens has a positive refractive power, an object-side surface of the third lens is configured as a convex surface proximal to the optical axis, and an image-side surface of the third lens is configured as a concave surface proximal to the optical axis. The fourth lens has a positive refractive power, an object-side surface of the fourth lens is configured as a convex surface proximal to the optical axis, and an image-side surface of the fourth lens is configured as a concave surface proximal to the optical axis.

In the optical system provided in the present disclosure, the high-quality imaging performance under low-light conditions can be achieved by matching the refractive powers of the four lenses. Specifically, the first lens has the negative refractive power, the object-side surface of the first lens is configured as the concave surface proximal to the circumference of the first lens, and the image-side surface of the first lens is configured as the convex surface proximal to the circumference of the first lens. This configuration facilitates the collection of incident rays over a wide field of view. In addition, the second lens has the refractive power, which helps correct aberrations introduced by the front lens. Furthermore, the third lens has the positive refractive power, the object-side surface of the third lens is configured as the convex surface proximal to the optical axis, and the image-side surface of the third lens is configured as the concave surface proximal to the optical axis. This configuration is beneficial for delaying the rays entering the system from the front-end lens, and delaying the angle of the rays. Moreover, the fourth lens has the positive refractive power, which helps correct the spherical aberration, coma, and distortion produced by the preceding lens group. The total length of the system can be shortened. Meanwhile, an emergence angle of the rays can be constrained, and rays over a large range can be incident to an imaging plane.

In an embodiment, the optical system satisfies the following relational expression: 0.9<FNO<1.3, where FNO represents an F-number of the optical system. When this relational expression is satisfied, it ensures that the optical system possesses the characteristic of a large pore size, allowing sufficient amount of incident light into the optical system and resulting in clearer captured images. Alternatively, FNO may have a value of 0.901, 0.930, 0.949, 0.950, 1.000, 1.050, 1.150, 1.200, 1.250, or 1.299.

In an embodiment, the optical system satisfies the following relational expression: 1600<FOV<177°, where FOV represents a maximum field of view of the optical system. When this relational expression is satisfied, the optical system can have a wide field of view (FOV), thereby expanding the shooting range. Furthermore, the optical system exhibits the features of high pixel count and high resolution. Alternatively, FOV may have a value of 160.001, 163.739, 164.939, 167.292, 169.773, 170.265, 170.543, 173.233, 176.617, or 176.999.

In an embodiment, the optical system may satisfy the following relational expression: 140°<FOV/FNO<180°. When this relational expression is satisfied, a lens assembly can achieve imaging with a wide field of view while ensuring a large amount of incident light, resulting in clear images. Alternatively, FOV/FNO may have a value of 140.001, 141.294, 148.056, 156.011, 159.326, 161.688, 166.568, 173.784, 179.519, or 179.999.

In an embodiment, the optical system may satisfy the following relational expression: 2.6<TTL/ImgH<2.8, where TTL may represent a distance from the object-side surface of the first lens to the imaging plane on the optical axis, and ImgH may represent a half of an image height corresponding to the maximum field of view of the optical system. When this relational expression is satisfied, the optical system may achieve an ultra-thin characteristic, offering advantages for imaging medium-distance objects and facilitating miniaturization of camera devices. Alternatively, TTL/ImgH may have a value of 2.601, 2.634, 2.676, 2.703, 2.754, 2.762, 2.776, 2.782, 2.792, or 2.799.

In an embodiment, the optical system may satisfy the following relational expression: 1.7<ImgH/BL<2.2, where BL may represent a minimum distance from the image-side surface of the fourth lens to the imaging plane. When this relational expression is satisfied, a larger focusing adjustment range can be provided during a calibration process of a lens module on one hand. On the other hand, as the lens module may be used to capture calibration charts in practice, a sufficiently long back focal length may ensure the lens can find the optimal focus point under such conditions. Alternatively, ImgH/BL may have a value of 1.701, 1.797, 1.865, 2.029, 2.035, 2.037, 2.057, 2.058, 2.119, or 2.199.

In an embodiment, the optical system may satisfy the following relational expression: 1.5<ImgH/EPD<2.2, where EPD may represent an entrance pupil diameter of the optical system. When this relational expression is satisfied, a screen size for a given eye pupil diameter can be constrained, and thus a selection direction for the screen can be clarified. Alternatively, ImgH/EPD may have a value of 1.501, 1.594, 1.674, 1.717, 1.724, 1.758, 1.864, 2.027, 2.115, or 2.199.

In an embodiment, the optical system may satisfy the following relational expression: −2.9<f1/f<−2, where f may represent an effective focal length of the optical system, and f1 may represent an effective focal length of the first lens. When this relational expression is satisfied, by controlling a ratio between the effective focal length of the first lens and that of the entire optical system within a specific range, the refractive power of the first lens relative to the effective focal length of the entire optical system may not be excessively strong. This may help correct high-order spherical aberration, enabling the optical system to achieve good imaging quality. Alternatively, f1/f may have a value of −2.001,−2.011,−2.035,−2.118,−2.192,−2.342,−2.545,−2.668,−2.859, or −2.899.

In an embodiment, the optical system may satisfy the following relational expression: 5<|f2|/f<40, where f2 may represent an effective focal length of the second lens. When this relational expression is satisfied, by controlling a ratio between the effective focal length of the second lens and that of the entire optical system within a specific range, the refractive power of the second lens relative to the effective focal length of the entire optical system may not be excessively strong. This may help correct high-order spherical aberration, enabling the optical system to achieve good imaging quality. Alternatively, |f2|/f may have a value of 5.001, 5.119, 5.506, 5.579, 5.829, 6.513, 7.685, 10.485, 37.560, or 39.999.

In an embodiment, the optical system may satisfy the following relational expression: 2.5<f3/f<9, where f3 may represent an effective focal length of the third lens. When this relational expression is satisfied, by controlling a ratio between the effective focal length of the third lens and that of the entire optical system within a specific range, the refractive power of the third lens relative to the effective focal length of the entire optical system may not be excessively strong. This may help correct high-order spherical aberration, enabling the optical system to achieve good imaging quality. Alternatively, f3/f may have a value of 2.601, 2.667, 2.831, 2.843, 3.005, 3.215, 3.812, 5.466, 8.644, or 8.999.

In an embodiment, the optical system may satisfy the following relational expression: 1.1<f4/f<1.4, where f4 may represent an effective focal length of the fourth lens. When this relational expression is satisfied, by controlling a ratio between the effective focal length of the fourth lens and that of the entire optical system within a specific range, the refractive power of the fourth lens relative to the effective focal length of the entire optical system may not be excessively strong. This may help correct high-order spherical aberration, enabling the optical system to achieve good imaging quality. Alternatively, f4/f may have a value of 1.101, 1.125, 1.170, 1.260, 1.273, 1.301, 1.305, 1.338, 1.340, or 1.399.

In an embodiment, the optical system may satisfy the following relational expression: −1.7<R1/f<−1.2, where R1 may represent a radius of curvature of the object-side surface of the first lens at the optical axis. When this relational expression is satisfied, by controlling a ratio between the radius of curvature of the first lens and the effective focal length of the entire optical system within a specific range, an astigmatism of the first lens can be kept within a reasonable range. This may effectively balance an astigmatism generated by the preceding lenses, thereby enabling the optical system to achieve good imaging quality. Alternatively, R1/f may have a value of −1.201, 1.309,−1.422,−1.468,−1.485,−1.547,−1.575,−1.598,−1.654, or −1.699.

In an embodiment, the optical system may satisfy the following relational expression: 6<R2|/f<28, where R2 may represent a radius of curvature of the image-side surface of the first lens at the optical axis. When this relational expression is satisfied, by controlling a ratio between the radius of curvature of the first lens and the effective focal length of the entire optical system within a specific range, the astigmatism of the first lens can be kept within a reasonable range. This may effectively balance the astigmatism generated by the preceding lenses, thereby enabling the optical system to achieve good imaging quality. Alternatively, |R2|/f may have a value of 6.001, 7.164, 7.465, 10.615, 10.725, 11.173, 11.734, 17.643, 24.600, or 27.999.

In an embodiment, the optical system may satisfy the following relational expression: 5<|R3/f<20, where R3 may represent a radius of curvature of the object-side surface of the second lens at the optical axis. When this relational expression is satisfied, by controlling a ratio between the radius of curvature of the second lens and the effective focal length of the entire optical system within a specific range, an astigmatism of the second lens can be kept within a reasonable range. This may effectively balance the astigmatism generated by the preceding lenses, thereby enabling the optical system to achieve good imaging quality. Alternatively, |R3|/fmay have a value of 5.001, 5.168, 5.761, 7.586, 7.826, 8.178, 9.548, 13.434, 18.904, or 19.999.

In an embodiment, the optical system may satisfy the following relational expression: 2.7<|R41/f<40, where R4 may represent a radius of curvature of the image-side surface of the second lens at the optical axis. When this relational expression is satisfied, by controlling a ratio between the radius of curvature of the second lens and the effective focal length of the entire optical system within a specific range, the astigmatism of the second lens can be kept within a reasonable range. This may effectively balance the astigmatism generated by the preceding lenses, thereby enabling the optical system to achieve good imaging quality. Alternatively, |R4|/f may have a value of 2.701, 2.784, 5.737, 6.074, 6.974, 7.084, 15.252, 22.844, 35.912, or 39.999.

In an embodiment, the optical system may satisfy the following relational expression: 1.2<R5/f<2.8, where R5 may represent a radius of curvature of the object-side surface of the third lens at the optical axis. When this relational expression is satisfied, by controlling a ratio between the radius of curvature of the third lens and the effective focal length of the entire optical system within a specific range, an astigmatism of the third lens can be kept within a reasonable range. This may effectively balance the astigmatism generated by the preceding lenses, thereby enabling the optical system to achieve good imaging quality. Alternatively, R5/f may have a value of 1.201, 1.298, 1.397, 1.427, 1.503, 1.532, 1.695, 2.086, 2.673, or 2.799.

In an embodiment, the optical system may satisfy the following relational expression: 3.2<R6/f<5, where R6 may represent a radius of curvature of the image-side surface of the third lens at the optical axis. When this relational expression is satisfied, by controlling a ratio between the radius of curvature of the third lens and the effective focal length of the entire optical system within a specific range, the astigmatism of the third lens can be kept within a reasonable range. This may effectively balance the astigmatism generated by the preceding lenses, thereby enabling the optical system to achieve good imaging quality. Alternatively, R6/f may have a value of 3.201, 3.471, 3.885, 3.891, 3.935, 4.175, 4.260, 4.531, 4.750, or 4.999.

In an embodiment, the optical system may satisfy the following relational expression: 1.5<f/R7<2, where R7 may represent a radius of curvature of the object-side surface of the fourth lens at the optical axis. When this relational expression is satisfied, by controlling a ratio between the radius of curvature of the fourth lens and the effective focal length of the entire optical system within a specific range, an astigmatism of the fourth lens can be kept within a reasonable range. This may effectively balance the astigmatism generated by the preceding lenses, thereby enabling the optical system to achieve good imaging quality. Alternatively, f/R7 may have a value of 1.501, 1.587, 1.682, 1.687, 1.715, 1.784, 1.816, 1.946, 1.987, and 1.999.

In an embodiment, the optical system may satisfy the following relational expression: 1<R8/f<2, where R8 may represent a radius of curvature of the image-side surface of the fourth lens at the optical axis. When this relational expression is satisfied, by controlling a ratio between the radius of curvature of the fourth lens and the effective focal length of the entire optical system within a specific range, the astigmatism of the fourth lens can be kept within a reasonable range. This may effectively balance the astigmatism generated by the preceding lenses, thereby enabling the optical system to achieve good imaging quality. Alternatively, R8/f may have a value of 1.001, 1.047, 1.134, 1.200, 1.334, 1.362, 1.494, 1.695, 1.882, or 1.999.

In an embodiment, the optical system may satisfy the following relational expression: 0.18<(R6−R5)/f3<1.1. When this relational expression is satisfied, the refractive power of the optical system may be reasonably distributed. This may allow the optical system to maintain a high aberration correction capability while achieving miniaturization and also enable better manufacturability. Alternatively, (R6−R5)/f3 may have a value of 0.181, 0.184, 0.574, 0.689, 0.743, 0.815, 0.897, 0.967, 1.071, or 1.099.

In an embodiment, the optical system may satisfy a relational expression: 1.3<ΣCT/XET<1.6, where ICT may represent a sum of center thicknesses of the first lens to the fourth lens at the optical axis, and ΣET may represent a sum of air gaps between the first lens and the fourth lens at the optical axis. When this relational expression is satisfied, sufficient air gaps may be ensured between the lenses and between the last lens and the imaging plane. This may not only be conductive to the structural design and assembly process of a lens barrel and the lenses, but also help balance the distortion better. In addition, a larger margin for molding and adjustment processes can be provided, avoiding cosmetic defects on the lenses that could lead to stray light risks. Furthermore, better matching between a chief ray angle and the photosensitive chip can be achieved. Alternatively, ICT/XET may have a value of 1.301, 1.352, 1.396, 1.437, 1.466, 1.474, 1.487, 1.502, 1.575, or 1.599.

In an embodiment, the optical system may satisfy the following relational expression: 1<CT2/CT1<1.7, where CT1 may represent a center thickness of the first lens at the optical axis, and CT2 may represent a center thickness of the second lens at the optical axis. By satisfying this relational expression, the center thicknesses of the first lens and the second lens on the optical axis may be reasonably controlled, which is beneficial to ensuring the manufacturability requirements of the molding of the two plastic lenses, and is also beneficial to correcting off-axis coma. Alternatively, CT2/CT1 may have a value of 1.001, 1.054, 1.169, 1.299, 1.358, 1.464, 1.550, 1.594, 1.683, or 1.699.

In an embodiment, the optical system may satisfy the following relational expression: 2.1<CT3/CT2<3.2, where CT3 may represent a center thickness of the third lens at the optical axis. By satisfying this relational expression, the center thicknesses of the second lens and the third lens on the optical axis may be reasonably controlled, which is beneficial to ensuring the manufacturability requirements of the molding of the two plastic lenses, and is also beneficial to correcting off-axis coma. Alternatively, CT3/CT2 may have a value of 2.101, 2.143, 2.544, 2.740, 2.837, 2.914, 2.992, 3.043, 3.126, or 3.199.

In an embodiment, the optical system may satisfy the following relational expression: 2.5<CT3/CT4<3.1, where CT4 may represent a center thickness of the fourth lens at the optical axis. By satisfying this relational expression, the center thicknesses of the third lens and the fourth lens on the optical axis may be reasonably controlled, which is beneficial to ensuring the manufacturability requirements of the molding of the two plastic lenses, and is also beneficial to correcting off-axis coma. Alternatively, CT3/CT4 may have a value of 2.501, 2.526, 2.672, 2.695, 2.734, 2.896, 2.973, 3.072, 3.097, or 3.099.

In an embodiment, the optical system may satisfy the following relational expression: 0.8<CT2/CT4<1.3. By satisfying this relational expression, the center thicknesses of the second lens and the fourth lens on the optical axis may be reasonably controlled, which is beneficial to ensuring the manufacturability requirements of the molding of the two plastic lenses, and is also beneficial to correcting off-axis coma. Alternatively, CT2/CT4 may have a value of 0.801, 0.830, 0.926, 0.950, 1.027, 1.063, 1.085, 1.134, 1.247, or 1.299.

In an embodiment, the optical system may satisfy the following relational expression: 0.6<(CT3+CT4)/ΣCT<0.71. Satisfying this relational expression may enable complementary thickness distribution among the lenses, essentially forming a “thin-thin-thick-thin” configuration. This may provide good offsetting effects for aberrations such as spherical aberration, astigmatism, and chromatic aberration, and also offer good complementary performance in extreme environments such as high temperature and low temperature. Alternatively, (CT3+CT4)/ΣCT may have a value of 0.601, 0.623, 0.649, 0.655, 0.677, 0.685, 0.696, 0.701, 0.704, or 0.709.

In an embodiment, the optical system may satisfy the following relational expression: 2.7<CT3/ET3<3.3, where ET3 may represent an edge thickness of the third lens at a peripheral region of the third lens. By satisfying this relational expression, it can be ensured that the thickness of the third lens is uniformly distributed at different positions, and the impact of the thickness non-uniformity of the third lens on the imaging quality of the optical system may be reduced. Meanwhile, a molding yield of the third lens can be improved. Alternatively, CT3/ET3 may have a value of 2.701, 2.794, 2.883, 2.956, 2.957, 2.968, 3.066, 3.143, 3.238, or 3.299.

In an embodiment, the optical system may satisfy the following relational expression: 0.3<SR/SD8<0.5, where SR may represent an effective semi-diameter of an aperture stop in the optical system, and SD8 may represent an effective semi-diameter of the image-side surface of the fourth lens. By satisfying this relational expression, on one hand, a vignetting value of the optical system can be effectively controlled, and rays with poor imaging quality may be blocked, so that the resolution of the optical system may be improved. On the other hand, step differences caused by diameter variations among the lenses can be avoided, and the assembly stability may be improved. Alternatively, SR/SD8 may have a value of 0.301, 0.331, 0.357, 0.381, 0.403, 0.428, 0.437, 0.445, 0.478, or 0.499.

In an embodiment, the optical system may satisfy the following relational expression: 1.7<SD1/SD2<1.9, where SD1 may represent an effective semi-diameter of the object-side surface of the first lens, and SD2 may represent an effective semi-diameter of the image-side surface of the first lens. Satisfying this relational expression may facilitate controlling the maximum clear aperture of the first lens, achieving the characteristics of large aperture and higher relative illumination. Alternatively, SD1/SD2 may have a value of 1.701, 1.736, 1.768, 1.775, 1.782, 1.792, 1.825, 1.854, 1.878, or 1.899.

In an embodiment, the optical system may satisfy the following relational expression: 1<SD1/ImgH<1.1. By satisfying this relational expression, a ratio between the half of the maximum effective diameter of the object-side surface of the first lens and the half of the image height corresponding to the maximum field of view of the optical system may be reasonably configured. This may be beneficial to reasonably controlling the size of the object-side surface of the first lens and achieving the miniaturization of the optical system. Alternatively, SD1/ImgH may have a value of 1.001, 1.014, 1.024, 1.031, 1.042, 1.049, 1.056, 1.069, 1.074, or 1.099.

In an embodiment, the optical system may satisfy the following relational expression: 1.1<SD1/SD8<1.2. Satisfying this relational expression may be beneficial to reducing an incident angle of the chief ray, improving the relative illuminance, and improving the imaging quality. Alternatively, SD1/SD8 may have a value of 1.101, 1.120, 1.137, 1.148, 1.155, 1.167, 1.168, 1.172, 1.190, or 1.199.

In an embodiment, the optical system may satisfy the following relational expression: 2.7<R6/SD6<3.3, where SD6 may represent an effective semi-diameter of the image-side surface of the third lens. Alternatively, R6/SD6 may have a value of 2.701, 2.786, 2.857, 2.972, 2.975, 3.070, 3.098, 3.133, 3.271, or 3.299.

In a second aspect, a lens module is further provided in the present disclosure. The lens module includes the optical system according to any one of the embodiments of the first aspect and a photosensitive chip disposed on the imaging side of the optical system.

In a third aspect, an electronic device is further provided in the present disclosure. The electronic device includes a housing and the lens module according to the second aspect. The lens module is disposed in the housing.

### First Embodiment

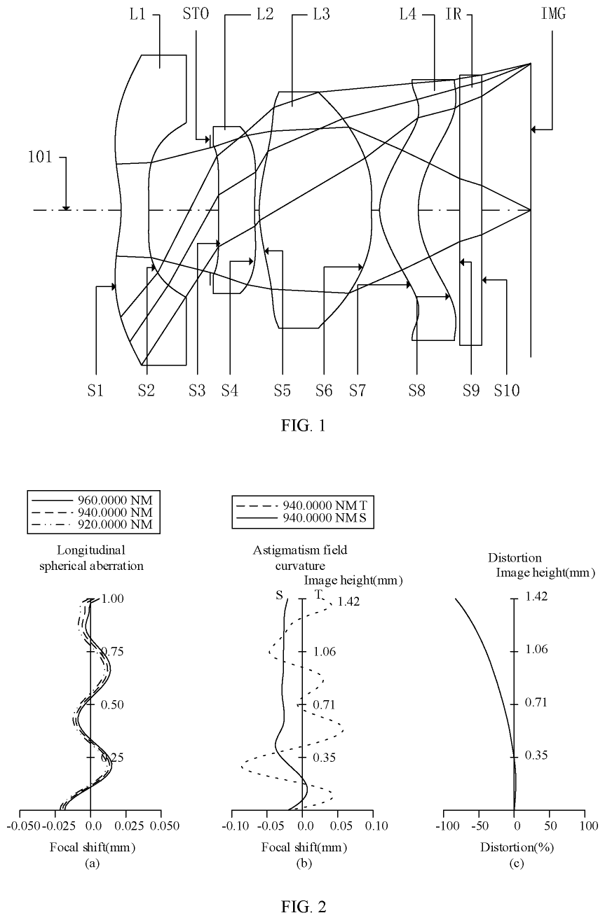

Referring to FIG. 1 and FIG. 2, the optical system 10 of the present embodiment sequentially includes, from an object side to an image side, a first lens L1, a second lens L2, a third lens L3, and a fourth lens L4.

The first lens L1 has a negative refractive power. An object-side surface S1 of the first lens L1 is configured as a concave surface proximal to an optical axis 101 of the optical system 10, and an image-side surface S2 of the first lens L1 is configured as a convex surface proximal to the optical axis 101 of the optical system 10. In addition, the object-side surface S1 of the first lens L1 is configured as a concave surface proximal to a circumference of the first lens L1, and the image-side surface S2 of the first lens L1 is configured as a convex surface proximal to the circumference of the first lens L1.

The second lens L2 has a negative refractive power. An object-side surface S3 of the second lens L2 is configured as a convex surface proximal to the optical axis 101 of the optical system 10, and an image-side surface S4 of the second lens L2 is configured as a concave surface proximal to the optical axis 101 of the optical system 10, In addition, the object-side surface S3 of the second lens L2 is configured as a concave surface proximal to a circumference of the second lens L2, and the image-side surface S4 of the second lens L2 is configured as a convex surface proximal to the circumference of the second lens L2.

The third lens L3 has a positive refractive power. An object-side surface S5 of the third lens L3 is configured as a convex surface proximal to the optical axis 101 of the optical system 10, and an image-side surface S6 of the third lens L3 is configured as a concave surface proximal to the optical axis 101 of the optical system 10. In addition, the object-side surface S5 of the third lens L3 is configured as a convex surface proximal to a circumference of the third lens L3, and the image-side surface S6 of the third lens L3 is configured as a concave surface proximal to the circumference of the third lens L3.

The fourth lens L4 has a positive refractive power. An object-side surface S7 of the fourth lens L4 is configured as a convex surface proximal to the optical axis 101 of the optical system 10, and an image-side surface S8 of the fourth lens L4 is configured as a concave surface proximal to the optical axis 101 of the optical system 10. In addition, the object-side surface S7 of the fourth lens L4 is configured as a convex surface proximal to a circumference of the fourth lens L4, and the image-side surface S8 of the fourth lens L4 is configured as a concave surface proximal to the circumference of the fourth lens L4.

Each of the first lens L1 to the fourth lens L4 may be made of plastic material. In other embodiments, the material of each lens may also be glass or a glass-plastic hybrid. That is, some lenses may be made of plastic, and others may be made of glass. In addition, the optical system 10 may further include an aperture stop STO, a filter IR, and an imaging plane IMG. The aperture stop STO may be disposed on the object-side surface S3 of the second lens L2 for controlling the amount of incident light. The filter IR may include an object-side surface S9 facing the fourth lens L4 and an image-side surface L10. The effective pixel area of the photosensitive chip may be located at the imaging plane IMG.

The filter IR may be an infrared cut-off filter, which is configured to filter out infrared ray, so that the ray incident on the imaging plane IMG is visible ray, with a wavelength of 380 nm to 780 nm. The infrared cut-off filter may be made of glass, and a coating can be applied on the lens. In other embodiments, the filter IR can also be an infrared pass filter, configured to filter visible light and allow only infrared light to pass through, which can be used for infrared imaging and the like.

Table 1 shows a characteristic table of the optical system 10 of the present embodiment. The “Y radius” in Table 1 may represent the radius of curvature of the object-side surface or the image-side surface having corresponding surface serial number at the optical axis 101. The surface serial number S1 and the surface serial number S2 may represent the object-side surface S1 and the image-side surface S2 of the first lens L1, respectively. That is, in the same lens, a surface with a smaller surface serial number is the object-side surface, and a surface with a larger surface serial number is the image-side surface. In the “Thickness” parameter column for the first lens L1, a first value may represent the thickness of the lens on the optical axis 101, and a second value may represent a distance between the image-side surface of the lens and the next optical surface (an object-side surface of the next lens or a surface of the aperture stop) on the optical axis 101.

TABLE 1
First Embodiment
f = 0.935 mm, FNO = 1.05, FOV = 167.292°, TTL = 3.941 mm, ImgH = 1.42 mm

| | | | | | | | | Effective | Y pore |
|---|---|---|---|---|---|---|---|---|---|
| Surface | | Surface | Y radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.224 | 0.266 | Plastic | 1.635 | 20.373 | −2.380 | 1.500 |
| | | surface | | | | | | | |
| S2 | | Aspherical | −6.980 | 0.591 | | | | | 0.845 |
| | | surface | | | | | | | |
| STO | Aperture | Spherical | Infinite | 0.081 | | | | | 0.603 |
| | stop | surface | | | | | | | |
| S3 | Second lens | Aspherical | 17.675 | 0.345 | Plastic | 1.644 | 19.243 | −4.786 | 0.625 |
| | L2 | surface | | | | | | | |
| S4 | | Aspherical | 2.603 | 0.046 | | | | | 0.808 |
| | | surface | | | | | | | |
| S5 | Third lens | Aspherical | 1.214 | 1.079 | Plastic | 1.644 | 19.243 | 2.493 | 1.093 |
| | L3 | surface | | | | | | | |
| S6 | | Aspherical | 3.245 | 0.079 | | | | | 1.165 |
| | | surface | | | | | | | |
| S7 | Fourth lens | Aspherical | 0.471 | 0.373 | Plastic | 1.644 | 19.243 | 1.094 | 1.225 |
| | L4 | surface | | | | | | | |
| S8 | | Aspherical | 0.979 | 0.400 | | | | | 1.261 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.452 | | | | | |
| | | surface | | | | | | | |
| IMG | Imaging | Spherical | Infinite | 0.020 | | | | | |
| | plane | surface | | | | | | | |

Reference wavelength is 940 nm

As shown in Table 1, f may represent an effective focal length of the optical system 10, FNO may represent an F-number of the optical system 10, FOV may represent a maximum field of view of the optical system 10, TTL may represent a distance from the object-side surface S1 of the first lens L1 to the imaging plane IMG on the optical axis 101, and ImgH may represent a half of an image height corresponding to the maximum field of view of the optical system.

In this embodiment, each of the first lens L1 to the fourth lens L4 may be an aspherical lens. The surface shape x of the aspherical surface may be defined by using, but not limited to, the following aspherical surface formula:

$$x = \frac{{ch}^{2}}{1 + \sqrt{1 - ( k + 1 ) {c}^{2} {h}^{2}}} + \sum {Aih}^{i}$$

In the formula, x may represent a distance from a corresponding point on the aspherical surface to a plane tangent to a vertex on the axis, h may represent a distance from the corresponding point on the aspherical surface to the optical axis 101, c may represent a curvature at the vertex of the aspherical surface, k may represent a conic coefficient, and Ai may represent a coefficient corresponding to the i-th order item in the aspherical surface formula. Table 2 provides the conic coefficient k and high-order coefficients A4, A6, A8, A10, A12, A14, A16, A18, A20, A22, A24, A26, A28, and A30 applicable to the aspherical surfaces in the first embodiment.

TABLE 2
First Embodiment
Aspherical coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.8652E−01 | −8.3955E+00 | 0.0000E+00 | −6.1317E+00 | −9.2646E−01 | 6.1679E−01 | −5.4778E+00 | −1.8819E+00 |
| A4 | 1.3072E+00 | −1.2020E−02 | −4.1921E−01 | −1.3103E+00 | −1.1635E+00 | −4.3480E+00 | 9.3130E−01 | 9.5311E−01 |
| A6 | −2.9605E+00 | 2.3782E+01 | 4.3994E+00 | 4.3331E+00 | 5.5971E+00 | 2.4656E+01 | −6.9769E+01 | −1.0882E+01 |
| A8 | 6.2999E+00 | −2.7205E+02 | −7.8652E+01 | −4.9999E+00 | −2.4461E+01 | −9.9984E+01 | 3.5212E+01 | 7.6514E+01 |
| A10 | −1.0375E+01 | 1.7869E+03 | 8.4712E+02 | −5.6397E+01 | 8.0208E+01 | 2.8540E+02 | −9.9792E+01 | −3.5526E+02 |
| A12 | 1.2586E+01 | −7.4649E+03 | −5.5549E+03 | 3.4156E+02 | −1.9171E+02 | −5.7321E+02 | 1.0387E+02 | 1.1238E+03 |
| A14 | −1.1020E+01 | 2.0536E+04 | 2.2079E+04 | −9.2722E+02 | 3.2761E+02 | 8.0945E+02 | 2.7208E+02 | −2.5013E+03 |
| A16 | 6.8564E+00 | −3.7430E+04 | −5.2119E+04 | 1.3872E+03 | −3.9292E+02 | −7.9698E+02 | −1.3164E+03 | 4.0009E+03 |
| A18 | −2.9518E+00 | 4.4385E+04 | 6.7223E+04 | −1.1071E+03 | 3.2153E+02 | 5.3454E+02 | 2.6733E+03 | −4.6517E+03 |
| A20 | 8.3528E−01 | −3.2525E+04 | −3.6525E+04 | 3.6912E+02 | −1.7031E+02 | −2.3241E+02 | −3.3527E+03 | 3.9375E+03 |
| A22 | −1.3968E−01 | 1.3123E+04 | 0.0000E+00 | 0.0000E+00 | 5.2480E+01 | 5.8965E+01 | 2.7965E+03 | −2.4025E+03 |
| A24 | 1.0458E−02 | −2.1554E+03 | 0.0000E+00 | 0.0000E+00 | −7.1296E+00 | −6.6151E+00 | −1.5608E+03 | 1.0298E+03 |
| A26 | 0.0000E+00 | 0.0000E+00 | 0.0000E+00 | 0.0000E+00 | 0.0000E+00 | 0.0000E+00 | 5.6179E+02 | −2.9430E+02 |
| A28 | 0.0000E+00 | 0.0000E+00 | 0.0000E+00 | 0.0000E+00 | 0.0000E+00 | 0.0000E+00 | −1.1811E+02 | 5.0367E+01 |
| A30 | 0.0000E+00 | 0.0000E+00 | 0.0000E+00 | 0.0000E+00 | 0.0000E+00 | 0.0000E+00 | 1.1031E+01 | −3.9049E+00 |

(a) in FIG. 2 shows longitudinal spherical aberration curves of the optical system in the first embodiment at wavelengths of 960.0000 nm, 940.000 nm, and 920.0000 nm. The horizontal axis (X-axis) may represent focal shift in millimeters (mm), and the vertical axis (Y-axis) may represent a normalized field of view. The longitudinal spherical aberration curves may illustrate the deviation of the focal points for rays of different wavelengths after passing through the lenses of the optical system. As can be seen from (a) in FIG. 2, the optical system in the first embodiment may exhibit favorable spherical aberration values, indicating good imaging quality of the optical system in the present embodiment.
(b) in FIG. 2 shows astigmatism curves of the optical system in the first embodiment at the wavelength of 940.000 nm. The horizontal axis (X-axis) may represent focal shift in millimeters (mm), and the vertical axis (Y-axis) may represent the half of the image height (ImgH) in millimeters (mm). In the astigmatism curves, T may represent the curvature of the imaging plane IMG in a tangential direction, and S may represent the curvature of the imaging plane IMG in a sagittal direction. It can be seen from (b) in FIG. 2 that the astigmatism of the optical system is well compensated.
(c) in FIG. 2 shows a distortion curve of the optical system in the first embodiment at a wavelength of 940.000 nm. The horizontal axis (X-axis) may represent distortion, and the vertical axis (Y-axis) may represent the half of the image height (ImgH) in millimeters (mm). The distortion curve may illustrate magnitudes of distortion corresponding to different field of view angles. It can be seen from (c) in FIG. 2 that the distortion of the optical system is well corrected at the wavelength of 940.000 nm.

It can be seen from (a), (b), and (c) in FIG. 2 that the optical system in the present embodiment has relatively small aberrations and good imaging quality, demonstrating excellent imaging performance.

### Second Embodiment

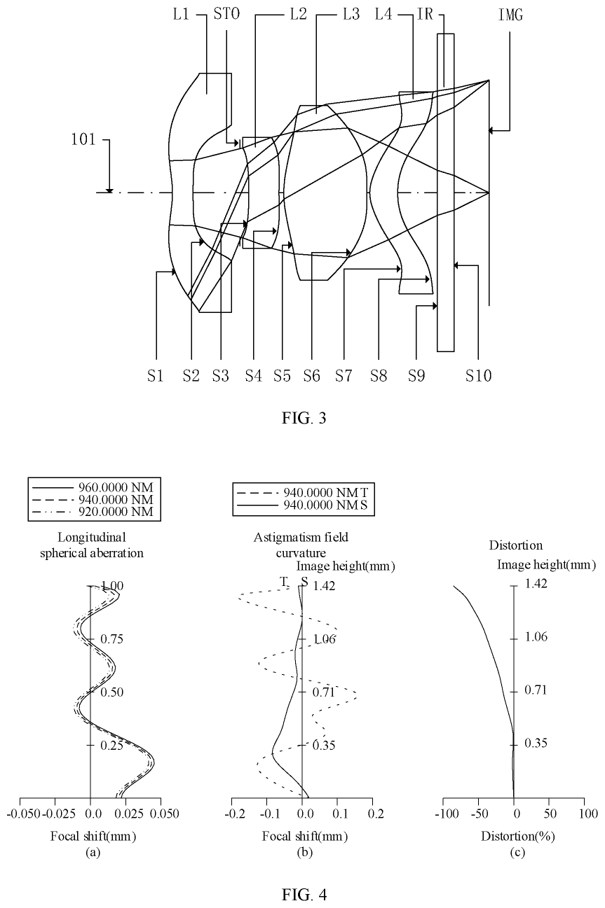

Referring to FIG. 3 and FIG. 4, the structure of the optical system 10 in the present embodiment may differ from that of the first embodiment in that: the image-side surface S2 of the first lens L1 may be configured as a concave surface at the optical axis; the object-side surface S3 of the second lens L2 may be configured as a concave surface at the optical axis, and the image-side surface S4 of the second lens L2 may be configured as a concave surface at the circumference of the second lens L2; and the object-side surface S7 of the fourth lens L4 may be configured as a concave surface at the circumference of the fourth lens L4, and the image-side surface S8 of the fourth lens L4 may be configured as a convex surface at the circumference of the fourth lens L4.

Table 3 shows a characteristic table of the optical system 10 in the present embodiment. The meanings of all parameters may be the same as those of the parameters in the first embodiment, which is not repeated herein.

TABLE 3
Second Embodiment
f = 0.848 mm, FNO = 1.05, FOV = 169.773°, TTL = 3.950 mm, ImgH = 1.42 mm

| | | | Y | | | | | Effective | Y pore |
|---|---|---|---|---|---|---|---|---|---|
| Surface | | Surface | radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.245 | −0.803 | Plastic | 1.635 | 20.373 | −1.705 | 1.503 |
| | | surface | | | | | | | |
| S2 | | Aspherical | 9.000 | 0.111 | | | | | 0.858 |
| | | surface | | | | | | | |
| STO | Aperture | Spherical | Infinite | 0.113 | | | | | 0.556 |
| | stop | surface | | | | | | | |
| S3 | Second lens | Aspherical | −8.095 | 0.377 | Plastic | 1.644 | 19.243 | −4.668 | 0.580 |
| | L2 | surface | | | | | | | |
| S4 | | Aspherical | 4.864 | 0.060 | | | | | 0.780 |
| | | surface | | | | | | | |
| S5 | Third lens | Aspherical | 1.184 | 1.034 | Plastic | 1.644 | 19.243 | 2.400 | 1.033 |
| | L3 | surface | | | | | | | |
| S6 | | Aspherical | 3.336 | 0.039 | | | | | 1.100 |
| | | surface | | | | | | | |
| S7 | Fourth lens | Aspherical | 0.467 | 0.348 | Plastic | 1.644 | 19.243 | 1.106 | 1.227 |
| | L4 | surface | | | | | | | |
| S8 | | Aspherical | 0.961 | 0.495 | | | | | 1.271 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.455 | | | | | |
| | | surface | | | | | | | |
| IMG | Imaging | Spherical | Infinite | −0.020 | | | | | |
| | plane | surface | | | | | | | |

Reference wavelength is 940 nm

Table 4 shows high-order coefficients applicable to the respective aspherical surfaces in the second embodiment. The surface shape of each aspherical surface may be defined by the formula given in the first embodiment.

TABLE 4
Second Embodiment
Aspherical Coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.8210E−01 | −9.9000E+01 | 9.9000E+01 | 1.3835E+00 | −8.4932E−01 | 3.3851E−01 | −4.7147E+00 | −1.4447E+00 |
| A4 | 1.4514E+00 | −1.9412E+00 | −1.5733E+00 | −7.9551E−01 | −1.1448E+00 | −4.4122E+00 | 9.4080E−01 | 4.8223E−01 |
| A6 | −3.1239E+00 | 4.9653E+01 | 4.1384E+01 | −3.6945E+00 | 5.6129E+00 | 2.6453E+01 | −1.0028E+01 | −1.6517E+00 |
| A8 | 5.8405E+00 | −4.4431E+02 | −7.2765E+02 | 4.8676E+01 | −2.6135E+01 | −1.1908E+02 | 7.0179E+01 | 4.1293E+00 |
| A10 | −8.3838E+00 | 2.5665E+03 | 7.2830E+03 | −2.4628E+02 | 9.0554E+01 | 3.8658E+02 | −2.8126E+02 | −7.6667E+00 |
| A12 | 9.1112E+00 | −1.0617E+04 | −4.4097E+04 | 6.6708E+02 | −2.2230E+02 | −8.8878E+02 | 6.9184E+02 | 2.3963E+00 |
| A14 | −7.3015E+00 | 3.2448E+04 | 1.6490E+05 | −1.0057E+03 | 3.7965E+02 | 1.4331E+03 | −1.1019E+03 | 2.0191E+01 |
| A16 | 4.1373E+00 | −7.1835E+04 | −3.7358E+05 | 7.8682E+02 | −4.4442E+02 | −1.6015E+03 | 1.1589E+03 | −4.4461E+01 |
| A18 | −1.5666E+00 | 1.0982E+05 | 4.7096E+05 | −2.3991E+02 | 3.4787E+02 | 1.2111E+03 | −7.9884E+02 | 4.5454E+01 |
| A20 | 3.6516E−01 | −1.0818E+05 | −2.5392E+05 | −7.9234E+00 | −1.7336E+02 | −5.9016E+02 | 3.4698E+02 | −2.5751E+01 |
| A22 | −4.5106E−02 | 6.1143E+04 | 0.0000E+00 | 0.0000E+00 | 4.9591E+01 | 1.6700E+02 | −8.6111E+01 | 7.7949E+00 |
| A24 | 2.0178E−03 | −1.4974E+04 | 0.0000E+00 | 0.0000E+00 | −6.1850E+00 | −2.0827E+01 | 9.3064E+00 | −9.8583E−01 |
| A26 | 0.0000E+00 | 0.0000E+00 | 0.0000E+00 | 0.0000E+00 | 0.0000E+00 | 0.0000E+00 | 0.0000E+00 | 0.0000E+00 |
| A28 | 0.0000E+00 | 0.0000E+00 | 0.0000E+00 | 0.0000E+00 | 0.0000E+00 | 0.0000E+00 | 0.0000E+00 | 0.0000E+00 |
| A30 | 0.0000E+00 | 0.0000E+00 | 0.0000E+00 | 0.0000E+00 | 0.0000E+00 | 0.0000E+00 | 0.0000E+00 | 0.0000E+00 |

FIG. 4 shows longitudinal spherical aberration curves, astigmatism curves, and a distortion curve of the optical system in the second embodiment. It can be seen from aberration diagrams in FIG. 4 that the longitudinal spherical aberration, field curvature, and distortion of the optical system are well controlled. Therefore, the optical system in the present embodiment has good imaging quality.

### Third Embodiment

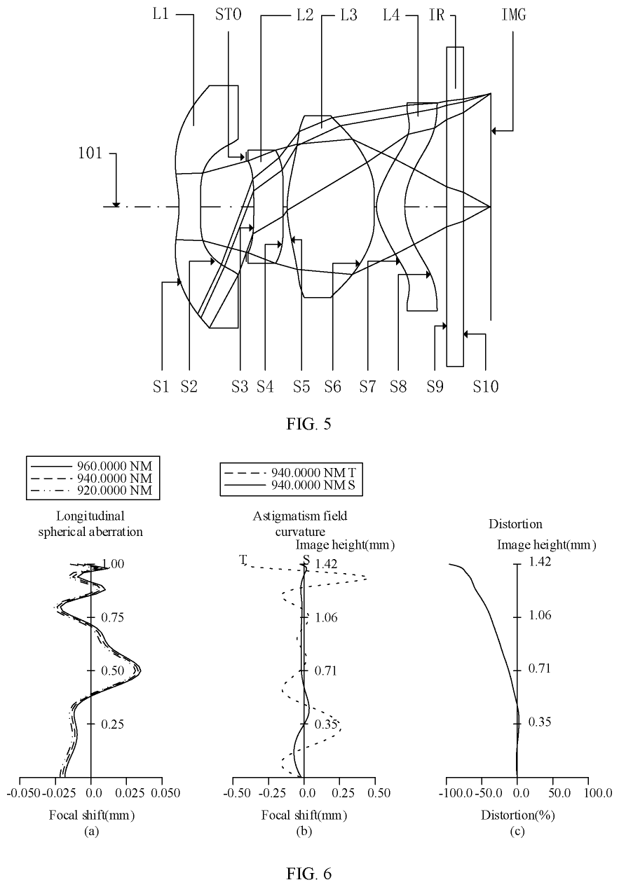

Referring to FIG. 5 and FIG. 6, the structure of the optical system 10 in the present embodiment may differ from that in the first embodiment in that: the image-side surface S2 of the first lens L1 may be configured as a concave surface at the optical axis; the object-side surface S3 of the second lens L2 may be configured as a concave surface at the optical axis, and the image-side surface S4 of the second lens L2 may be configured as a concave surface at the circumference of the second lens L2; and the object-side surface S7 of the fourth lens L4 may be configured as a concave surface at the circumference of the fourth lens L4, and the image-side surface S8 of the fourth lens L4 may be configured as a convex surface at the circumference of the fourth lens L4.

Table 5 shows a characteristic table of the optical system 10 in the present embodiment. The meanings of all parameters may be the same as those of the parameters in the first embodiment, which is not repeated herein.

TABLE 5
Third Embodiment
f = 0.783 mm, FNO = 0.950, FOV = 170.543°, TTL = 3.910 mm, ImgH = 1.42 mm

| | | | | | | | | Effective | Y pore |
|---|---|---|---|---|---|---|---|---|---|
| Surface | | Surface | Y radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.250 | 0.268 | Plastic | 1.635 | 20.373 | −1.715 | 1.518 |
| | | surface | | | | | | | |
| S2 | | Aspherical | 9.182 | 0.576 | | | | | 0.852 |
| | | surface | | | | | | | |
| STO | Aperture | Spherical | Infinite | 0.095 | | | | | 0.569 |
| | stop | surface | | | | | | | |
| S3 | Second lens | Aspherical | −6.399 | 0.364 | Plastic | 1.644 | 19.243 | −4.561 | 0.574 |
| | L2 | surface | | | | | | | |
| S4 | | Aspherical | 5.544 | 0.054 | | | | | 0.709 |
| | | surface | | | | | | | |
| S5 | Third lens | Aspherical | 1.199 | 1.090 | Plastic | 1.644 | 19.243 | 2.352 | 1.016 |
| | L3 | surface | | | | | | | |
| S6 | | Aspherical | 3.717 | 0.030 | | | | | 1.137 |
| | | surface | | | | | | | |
| S7 | Fourth lens | Aspherical | 0.464 | 0.355 | Plastic | 1.644 | 19.243 | 1.047 | 1.271 |
| | L4 | surface | | | | | | | |
| S8 | | Aspherical | 1.044 | 0.527 | | | | | 1.301 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.323 | | | | | |
| | | surface | | | | | | | |
| IMG | Imaging | Spherical | Infinite | 0.020 | | | | | |
| | plane | surface | | | | | | | |

Reference wavelength is 940 nm

Table 6 shows high-order coefficients applicable to the respective aspherical surfaces in the third embodiment. The surface shape of each aspherical surface may be defined by the formula given in the first embodiment.

TABLE 6
Third Embodiment
Aspherical Coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.8605E−01 | −3.2763E+00 | 6.5479E+01 | 1.8858E+01 | −8.4420E−01 | 4.7819E−01 | −4.6267E+00 | −1.4234E+00 |
| A4 | 1.5168E+00 | −2.5424E+00 | 1.8100E+00 | 1.5637E+00 | −1.1685E+00 | −3.5458E+00 | 2.7830E+00 | 2.1302E+00 |
| A6 | −3.9946E+00 | 8.9718E+01 | −1.3784E+02 | −9.1941E+01 | 5.7302E+00 | 1.4815E+01 | −3.8269E+01 | −2.5390E+01 |
| A8 | 1.0214E+01 | −1.2147E+03 | 4.6426E+03 | 1.7215E+03 | −2.7058E+01 | −5.3109E+01 | 2.7881E+02 | 1.6792E+02 |
| A10 | −1.9974E+01 | 9.8412E+03 | −9.4410E+04 | −1.8940E+04 | 9.6798E+01 | 1.8814E+02 | −1.2627E+03 | −7.1261E+02 |
| A12 | 2.7576E+01 | −5.0650E+04 | 1.2520E+06 | 1.3370E+05 | −2.4271E+02 | −6.0939E+02 | 3.8675E+03 | 2.0673E+03 |
| A14 | −2.6124E+01 | 1.7088E+05 | −1.1262E+07 | −6.3041E+05 | 3.9735E+02 | 1.5851E+03 | −8.3736E+03 | −4.2478E+03 |
| A16 | 1.6745E+01 | −3.8198E+05 | 6.9831E+07 | 2.0232E+06 | −3.5121E+02 | −3.1296E+03 | 1.3108E+04 | 6.2895E+03 |
| A18 | −7.1054E+00 | 5.5965E+05 | −2.9795E+08 | −4.4289E+06 | −4.4432E+01 | 4.6249E+03 | −1.4981E+04 | −6.7531E+03 |
| A20 | 1.9062E+00 | −5.1589E+05 | 8.5719E+08 | 6.5026E+06 | 5.9420E+02 | −5.0798E+03 | 1.2489E+04 | 5.2443E+03 |
| A22 | −2.9204E−01 | 2.7107E+05 | −1.5853E+09 | −6.1202E+06 | −8.8044E+02 | 4.0833E+03 | −7.4997E+03 | −2.9074E+03 |
| A24 | 1.9428E−02 | −6.1847E+04 | 1.6989E+09 | 3.3347E+06 | 7.2898E+02 | −2.3276E+03 | 3.1547E+03 | 1.1189E+03 |
| A26 | 0.0000E+00 | 0.0000E+00 | −8.0097E+08 | −7.9934E+05 | −3.7086E+02 | 8.8798E+02 | −8.8083E+02 | −2.8334E+02 |
| A28 | 0.0000E+00 | 0.0000E+00 | 0.0000E+00 | 0.0000E+00 | 1.0859E+02 | −2.0258E+02 | 1.4642E+02 | 4.2361E+01 |
| A30 | 0.0000E+00 | 0.0000E+00 | 0.0000E+00 | 0.0000E+00 | −1.4034E+01 | 2.0822E+01 | −1.0954E+01 | −2.8272E+00 |

FIG. 6 shows longitudinal spherical aberration curves, astigmatism curves, and a distortion curve of the optical system in the third embodiment. It can be seen from the aberration diagrams in FIG. 6 that the longitudinal spherical aberration, field curvature, and distortion of the optical system are well controlled. Therefore, the optical system in the present embodiment has good imaging quality.

### Fourth Embodiment

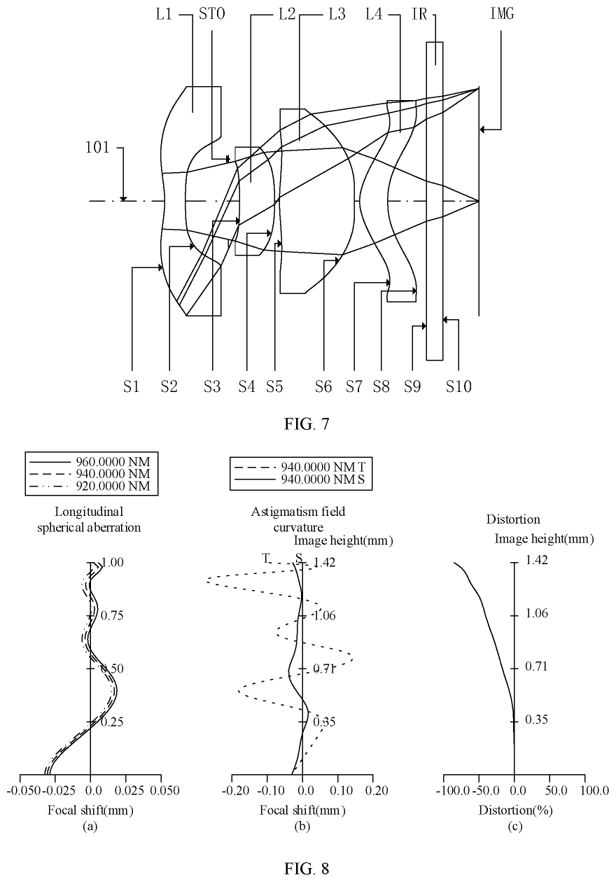

Referring to FIG. 7 and FIG. 8, the structure of the optical system 10 in the present embodiment may differ from that in the first embodiment in that: the image-side surface S2 of the first lens L1 may be configured as a concave surface at the optical axis; the second lens L2 may have a positive refractive power, the object-side surface S3 of the second lens L2 may be configured as a concave surface at the optical axis, the image-side surface S4 of the second lens L2 may be configured as a convex surface at the optical axis, the object-side surface S3 of the second lens L2 may be configured as a convex surface at the circumference of the second lens L2, and the image-side surface S4 of the second lens L2 may be configured as a concave surface at the circumference of the second lens L2; and the object-side surface S7 of the fourth lens L4 may be configured as a concave surface at the circumference of the fourth lens L4, and the image-side surface S8 of the fourth lens L4 may be configured as a convex surface at the circumference of the fourth lens L4.

Table 7 shows a characteristic table of the optical system 10 in the present embodiment. The meanings of all parameters may be the same as those of the parameters in the first embodiment, which is not repeated herein.

TABLE 7
Fourth Embodiment
f = 0.805 mm, FNO = 1.15, FOV = 170.265°, TTL = 3.965 mm, ImgH = 1.42 mm

| | | | | | | | | Effective | Y pore |
|---|---|---|---|---|---|---|---|---|---|
| Surface | | Surface | Y radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.246 | 0.262 | Plastic | 1.635 | 20.373 | −1.706 | 1.444 |
| | | surface | | | | | | | |
| S2 | | Aspherical | 9.000 | 0.542 | | | | | 0.815 |
| | | surface | | | | | | | |
| STO | Aperture | Spherical | Infinite | 0.141 | | | | | 0.482 |
| | stop | surface | | | | | | | |
| S3 | Second lens | Aspherical | −6.303 | 0.441 | Plastic | 1.644 | 19.243 | 30.255 | 0.597 |
| | L2 | surface | | | | | | | |
| S4 | | Aspherical | −4.892 | 0.062 | | | | | 0.788 |
| | | surface | | | | | | | |
| S5 | Third lens | Aspherical | 2.153 | 0.945 | Plastic | 1.644 | 19.243 | 6.963 | 1.077 |
| | L3 | surface | | | | | | | |
| S6 | | Aspherical | 3.432 | 0.066 | | | | | 1.162 |
| | | surface | | | | | | | |
| S7 | Fourth lens | Aspherical | 0.479 | 0.354 | Plastic | 1.644 | 19.243 | 1.079 | 1.236 |
| | L4 | surface | | | | | | | |
| S8 | | Aspherical | 1.097 | 0.490 | | | | | 1.266 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.423 | | | | | |
| | | surface | | | | | | | |
| IMG | Imaging | Spherical | Infinite | 0.031 | | | | | |
| | plane | surface | | | | | | | |

Reference wavelength is 940 nm

Table 8 shows high-order coefficients applicable to the respective aspherical surfaces in the fourth embodiment. The surface shape of each aspherical surface may be defined by the formula given in the first embodiment.

TABLE 8
Fourth Embodiment
Aspherical Coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.7638E−01 | −6.8110E+00 | −5.9325E+01 | 2.9612E+01 | −3.4141E−01 | −3.9384E+00 | −5.1585E+00 | −1.4879E+00 |
| A4 | 1.5186E+00 | 9.6767E−01 | 1.3542E−02 | −1.4176E+00 | −1.2367E+00 | −4.3314E+00 | 4.8584E−01 | 2.1302E−01 |
| A6 | −4.6778E+00 | 2.1896E+00 | −2.2961E+01 | 1.2165E+01 | 9.0456E+00 | 2.6126E+01 | −2.5750E+00 | 4.7706E+00 |
| A8 | 1.4026E+01 | −1.5586E+02 | 4.6049E+02 | −1.1922E+02 | −5.7390E+01 | −1.1670E+02 | 1.6641E+01 | −4.8278E+01 |
| A10 | −3.0352E+01 | 2.3730E+03 | −4.9653E+03 | 7.4408E+02 | 2.3878E+02 | 3.6712E+02 | −7.4008E+01 | 2.0564E+02 |
| A12 | 4.4752E+01 | −1.7535E+04 | 3.1031E+04 | −2.8887E+03 | −6.5327E+02 | −8.0418E+02 | 2.0548E+02 | −5.0648E+02 |
| A14 | −4.4696E+01 | 7.6195E+04 | −1.1542E+05 | 6.9446E+03 | 1.2010E+03 | 1.2214E+03 | −3.6835E+02 | 7.8662E+02 |
| A16 | 3.0098E+01 | −2.0893E+05 | 2.4849E+05 | −1.0028E+04 | −1.4943E+03 | −1.2757E+03 | 4.3156E+02 | −7.9544E+02 |
| A18 | −1.3394E+01 | 3.6702E+05 | −2.8160E+05 | 7.9349E+03 | 1.2409E+03 | 8.9697E+02 | −3.2711E+02 | 5.2358E+02 |
| A20 | 3.7534E+00 | −4.0098E+05 | 1.2759E+05 | −2.6311E+03 | −6.5820E+02 | −4.0513E+02 | 1.5420E+02 | −2.1662E+02 |
| A22 | −5.9590E−01 | 2.4791E+05 | 0.0000E+00 | 0.0000E+00 | 2.0148E+02 | 1.0610E+02 | −4.1032E+01 | 5.1209E+01 |
| A24 | 4.0501E−02 | −6.6174E+04 | 0.0000E+00 | 0.0000E+00 | −2.7059E+01 | −1.2240E+01 | 4.7029E+00 | −5.2802E+00 |
| A26 | 0.0000E+00 | 0.0000E+00 | 0.0000E+00 | 0.0000E+00 | 0.0000E+00 | 0.0000E+00 | 0.0000E+00 | 0.0000E+00 |
| A28 | 0.0000E+00 | 0.0000E+00 | 0.0000E+00 | 0.0000E+00 | 0.0000E+00 | 0.0000E+00 | 0.0000E+00 | 0.0000E+00 |
| A30 | 0.0000E+00 | 0.0000E+00 | 0.0000E+00 | 0.0000E+00 | 0.0000E+00 | 0.0000E+00 | 0.0000E+00 | 0.0000E+00 |

FIG. 8 shows longitudinal spherical aberration curves, astigmatism curves, and a distortion curve of the optical system in the fourth embodiment. It can be seen from the aberration diagrams in FIG. 8 that the longitudinal spherical aberration, field curvature, and distortion of the optical system are well controlled. Therefore, the optical system in the present embodiment has good imaging quality.

### Fifth Embodiment

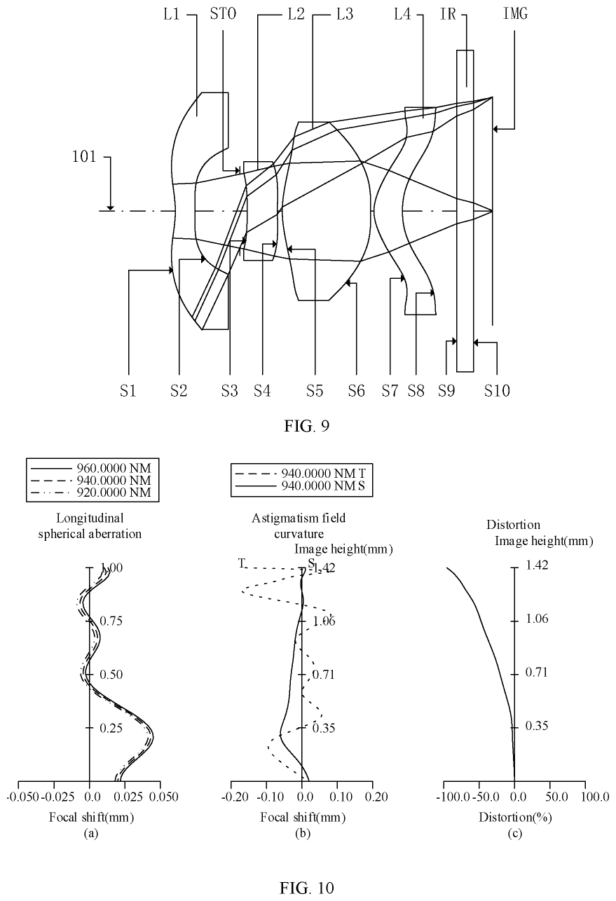

Referring to FIG. 9 and FIG. 10, the structure of the optical system 10 in the present embodiment may differ from that in the first embodiment in that: the image-side surface S2 of the first lens L1 may be configured as a concave surface at the optical axis; the object-side surface S3 of the second lens L2 may be configured as a concave surface at the optical axis; and the object-side surface S7 of the fourth lens L4 may be configured as a concave surface at the circumference of the fourth lens L4, and the image-side surface S8 of the fourth lens L4 may be configured as a convex surface at the circumference of the fourth lens L4.

Table 9 shows a characteristic table of the optical system 10 in the present embodiment. The meanings of all parameters may be the same as those of the parameters in the first embodiment, which is not repeated herein.

TABLE 9
Fifth Embodiment
f = 0.839 mm, FNO = 1.25, FOV = 176.617°, TTL = 3.922 mm, ImgH = 1.42 mm

| | | | | | | | | Effective | Y pore |
|---|---|---|---|---|---|---|---|---|---|
| Surface | | Surface | Y radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.246 | 0.241 | Plastic | 1.635 | 20.373 | −1.707 | 1.475 |
| | | surface | | | | | | | |
| S2 | | Aspherical | 8.999 | 0.558 | | | | | 0.788 |
| | | surface | | | | | | | |
| STO | Aperture | Spherical | Infinite | 0.089 | | | | | 0.460 |
| | stop | surface | | | | | | | |
| S3 | Second lens | Aspherical | −6.365 | 0.373 | Plastic | 1.644 | 19.243 | −4.681 | 0.470 |
| | L2 | surface | | | | | | | |
| S4 | | Aspherical | 5.852 | 0.060 | | | | | 0.615 |
| | | surface | | | | | | | |
| S5 | Third lens | Aspherical | 1.197 | 1.088 | Plastic | 1.644 | 19.243 | 2.386 | 0.925 |
| | L3 | surface | | | | | | | |
| S6 | | Aspherical | 3.504 | 0.045 | | | | | 1.108 |
| | | surface | | | | | | | |
| S7 | Fourth lens | Aspherical | 0.470 | 0.351 | Plastic | 1.644 | 19.243 | 1.091 | 1.246 |
| | L4 | surface | | | | | | | |
| S8 | | Aspherical | 1.007 | 0.671 | | | | | 1.290 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.255 | | | | | |
| | | surface | | | | | | | |
| IMG | Imaging | Spherical | Infinite | −0.020 | | | | | |
| | plane | surface | | | | | | | |

Reference wavelength is 940 nm

Table 10 shows high-order coefficients applicable to the respective aspherical surfaces in the fifth embodiment. The surface shape of each aspherical surface may be defined by the formula given in the first embodiment.

TABLE 10
Fifth Embodiment
Aspherical Coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.8266E−01 | 7.7488E+01 | 5.4034E+01 | 1.3678E+00 | −8.5198E−01 | 9.7135E−02 | −4.6079E+00 | −1.4619E+00 |
| A4 | 1.3854E+00 | 1.4878E+00 | −1.5544E+00 | −9.4503E−01 | −1.0757E+00 | −4.4685E+00 | 4.4863E−01 | 3.3992E−01 |
| A6 | −2.5293E+00 | 4.6916E+01 | 4.0960E+01 | 1.6817E+00 | 4.6451E+00 | 2.7720E+01 | −2.2899E+00 | 1.8555E+00 |
| A8 | 3.5418E+00 | −4.4539E+02 | −7.3467E+02 | 4.0736E+01 | −1.9615E+01 | −1.2930E+02 | 1.7054E+01 | −2.3869E+01 |
| A10 | −3.1115E+00 | 2.5618E+03 | 7.4751E+03 | −2.8320E+02 | 6.2299E+01 | 4.2988E+02 | −7.9182E+01 | 1.0429E+02 |
| A12 | 1.0546E+00 | 9.6804E+03 | −4.4723E+04 | 1.1193E+03 | 1.4020E+02 | −1.0020E+03 | 2.1769E+02 | −2.6063E+02 |
| A14 | 1.1397E+00 | 2.4865E+04 | 1.5783E+05 | −2.7152E+03 | 2.2063E+02 | 1.6285E+03 | −3.7771E+02 | 4.1056E+02 |
| A16 | −1.8919E+00 | −4.3927E+04 | −3.1576E+05 | 3.9687E+03 | 2.4187E+02 | 1.8292E+03 | 4.2388E+02 | −4.2145E+02 |
| A18 | 1.2994E+00 | 5.2962E+04 | 3.1661E+05 | −3.1983E+03 | 1.8251E+02 | 1.3887E+03 | −3.0641E+02 | 2.8196E+02 |
| A20 | −4.9849E−01 | −4.1890E+04 | −1.1032E+05 | 1.0907E+03 | −9.1320E+01 | −6.7930E+02 | 1.3759E+02 | −1.1870E+02 |
| A22 | 1.0377E−01 | 1.9607E+04 | 0.0000E+00 | 0.0000E+00 | 2.7570E+01 | 1.9304E+02 | −3.4895E+01 | 2.8576E+01 |
| A24 | −9.1437E−03 | −4.0968E+03 | 0.0000E+00 | 0.0000E+00 | −3.8334E+00 | −2.4198E+01 | 3.8181E+00 | −3.0008E+00 |
| A26 | 0.0000E+00 | 0.0000E+00 | 0.0000E+00 | 0.0000E+00 | 0.0000E+00 | 0.0000E+00 | 0.0000E+00 | 0.0000E+00 |
| A28 | 0.0000E+00 | 0.0000E+00 | 0.0000E+00 | 0.0000E+00 | 0.0000E+00 | 0.0000E+00 | 0.0000E+00 | 0.0000E+00 |
| A30 | 0.0000E+00 | 0.0000E+00 | 0.0000E+00 | 0.0000E+00 | 0.0000E+00 | 0.0000E+00 | 0.0000E+00 | 0.0000E+00 |

FIG. 10 shows longitudinal spherical aberration curves, astigmatism curves, and a distortion curve of the optical system in the fifth embodiment. It can be seen from the aberration diagrams in FIG. 10 that the longitudinal spherical aberration, field curvature, and distortion of the optical system are well controlled. Therefore, the optical system in the present embodiment has good imaging quality.

### Sixth Embodiment

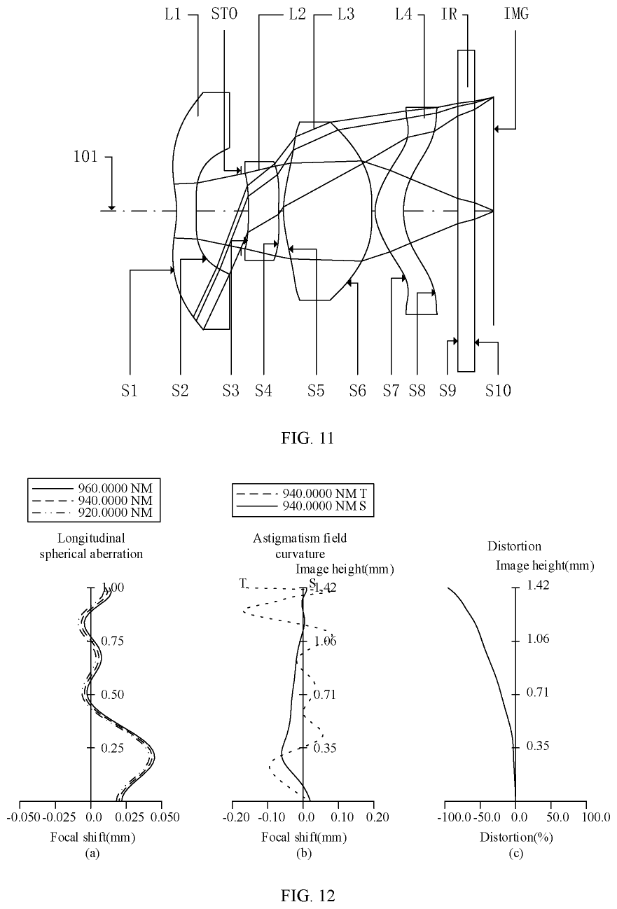

Referring to FIG. 11 and FIG. 12, the structure of the optical system 10 in the present embodiment may differ from that in the first embodiment in that: the image-side surface S2 of the first lens L1 may be configured as a concave surface at the optical axis; the object-side surface S3 of the second lens L2 may be configured as a concave surface at the optical axis; the object-side surface S7 of the fourth lens L4 may be configured as a concave surface at the circumference of the fourth lens L4, and the image-side surface S8 of the fourth lens L4 may be configured as a convex surface at the circumference of the fourth lens L4.

Table 11 shows a characteristic table of the optical system 10 in the present embodiment. The meanings of all parameters may be the same as those of the parameters in the first embodiment, which is not repeated herein.

TABLE 11
Sixth Embodiment
f = 0.868 mm, FNO = 1.05, FOV = 163.739°, TTL = 3.800 mm, ImgH = 1.42 mm

| | | | | | | | | Effective | Y pore |
|---|---|---|---|---|---|---|---|---|---|
| Surface | | Surface | Y radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.234 | 0.294 | Plastic | 1.635 | 20.373 | −2.482 | 1.454 |
| | | surface | | | | | | | |
| S2 | | Aspherical | −6.219 | 0.520 | | | | | 0.812 |
| | | surface | | | | | | | |
| STO | Aperture | Spherical | Infinite | 0.118 | | | | | 0.554 |
| | stop | surface | | | | | | | |
| S3 | Second lens | Aspherical | −4.486 | 0.343 | Plastic | 1.644 | 19.243 | −5.653 | 0.572 |
| | L2 | surface | | | | | | | |
| S4 | | Aspherical | 19.828 | 0.069 | | | | | 0.742 |
| | | surface | | | | | | | |
| S5 | Third lens | Aspherical | 1.305 | 0.974 | Plastic | 1.644 | 19.243 | 2.791 | 1.011 |
| | L3 | surface | | | | | | | |
| S6 | | Aspherical | 3.377 | 0.076 | | | | | 1.100 |
| | | surface | | | | | | | |
| S7 | Fourth lens | Aspherical | 0.506 | 0.362 | Plastic | 1.644 | 19.243 | 1.094 | 1.194 |
| | L4 | surface | | | | | | | |
| S8 | | Aspherical | 1.297 | 0.563 | | | | | 1.245 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.251 | | | | | |
| | | surface | | | | | | | |
| IMG | Imaging | Spherical | Infinite | 0.020 | | | | | |
| | plane | surface | | | | | | | |

Reference wavelength is 940 nm

Table 12 shows high-order coefficients applicable to the respective aspherical surfaces in the sixth embodiment. The surface shape of each aspherical surface may be defined by the formula given in the first embodiment.

TABLE 12
Sixth Embodiment
Aspherical Coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.9193E−01 | 1.7757E+01 | 4.4441E+01 | 9.9000E+01 | −7.6199E−01 | −2.9307E+00 | −4.8548E+00 | −1.1336E+00 |
| A4 | 1.2710E+00 | 1.3191E+00 | −2.0844E−01 | −1.4638E+00 | −1.0676E+00 | −3.6065E+00 | 6.7448E−01 | 1.1911E+00 |
| A6 | −2.1346E+00 | −1.0499E+00 | 4.4998E+00 | 8.0113E+00 | 5.3492E+00 | 1.8561E+01 | −3.4253E+00 | −7.5849E+00 |
| A8 | 2.2459E+00 | 1.1976E+01 | 1.0068E+02 | −4.6015E+01 | −2.5262E+01 | −7.3126E+01 | 1.6910E+01 | 3.7878E+01 |
| A10 | 6.2097E−01 | −1.6120E+02 | −1.2175E+03 | 1.8508E+02 | 8.8789E+01 | 2.0860E+02 | −6.2743E+01 | −1.4926E+02 |
| A12 | −6.1608E+00 | 9.5206E+02 | 8.7450E+03 | −4.9905E+02 | −2.2327E+02 | −4.2248E+02 | 1.5476E+02 | 4.3449E+02 |
| A14 | 1.0155E+01 | −2.9470E+03 | −3.8570E+04 | 8.7225E+02 | 3.9597E+02 | 6.0096E+02 | −2.5675E+02 | −9.3205E+02 |
| A16 | −9.2472E+00 | 5.0445E+03 | 1.0200E+05 | −9.3493E+02 | −4.8846E+02 | −5.9208E+02 | 2.8570E+02 | 1.4762E+03 |
| A18 | 5.2084E+00 | −4.4965E+03 | −1.4794E+05 | 5.5084E+02 | 4.0889E+02 | 3.9322E+02 | −2.0893E+02 | −1.7236E+03 |
| A20 | −1.8059E+00 | 1.6200E+03 | 9.0096E+04 | −1.3351E+02 | −2.2110E+02 | −1.6685E+02 | 9.5999E+01 | 1.4740E+03 |
| A22 | 3.5410E−01 | 0.0000E+00 | 0.0000E+00 | 0.0000E+00 | 6.9607E+01 | 4.0476E+01 | −2.5087E+01 | −9.1032E+02 |
| A24 | −3.0090E−02 | 0.0000E+00 | 0.0000E+00 | 0.0000E+00 | −9.6873E+00 | −4.2119E+00 | 2.8417E+00 | 3.9481E+02 |
| A26 | 0.0000E+00 | 0.0000E+00 | 0.0000E+00 | 0.0000E+00 | 0.0000E+00 | 0.0000E+00 | 0.0000E+00 | −1.1408E+02 |
| A28 | 0.0000E+00 | 0.0000E+00 | 0.0000E+00 | 0.0000E+00 | 0.0000E+00 | 0.0000E+00 | 0.0000E+00 | 1.9730E+01 |
| A30 | 0.0000E+00 | 0.0000E+00 | 0.0000E+00 | 0.0000E+00 | 0.0000E+00 | 0.0000E+00 | 0.0000E+00 | −1.5469E+00 |

FIG. 12 shows longitudinal spherical aberration curves, astigmatism curves, and a distortion curve of the optical system in the sixth embodiment. It can be seen from the aberration diagrams in FIG. 12 that the longitudinal spherical aberration, field curvature, and distortion of the optical system are well controlled. Therefore, the optical system in the present embodiment has good imaging quality.

### Seventh Embodiment

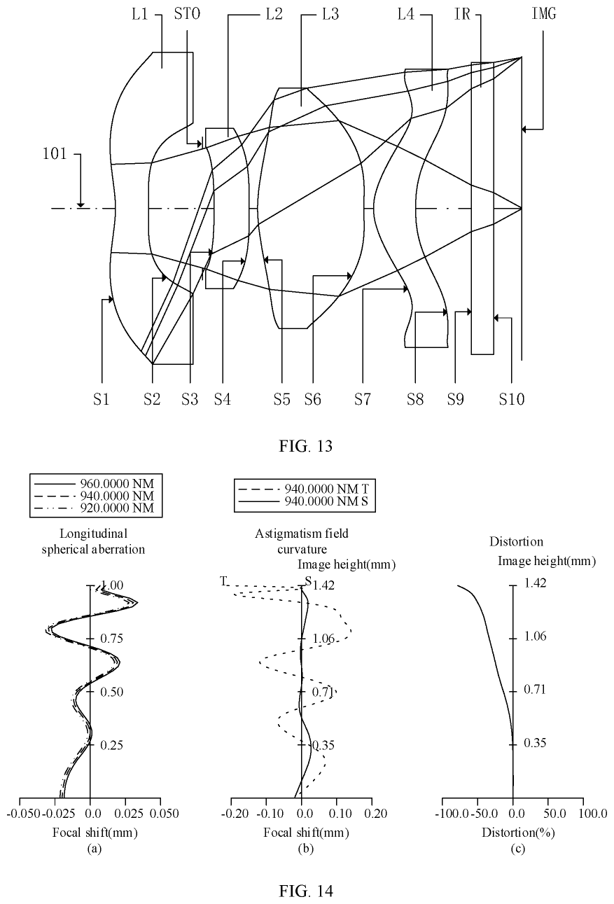

Referring to FIG. 13 and FIG. 14, the structure of the optical system 10 in the present embodiment may differ from that in the first embodiment in that the object-side surface S3 of the second lens L2 may be configured as a concave surface at the optical axis.

Table 13 shows a characteristic table of the optical system 10 in the present embodiment. The meanings of all parameters may be the same as those of the parameters in the first embodiment, which is not repeated herein.

TABLE 13
Seventh Embodiment
f = 0.785 mm, FNO = 0.949, FOV = 164.939°, TTL = 3.800 mm, ImgH = 1.42 mm

| | | | | | | | | Effective | Y pore |
|---|---|---|---|---|---|---|---|---|---|
| Surface | | Surface | Y radius | Thickness | | Refractive | Abbe | focus | size |
| No. | Name | type | (mm) | (mm) | Materials | index | number | (mm) | (mm) |
| Object | Object | Spherical | Infinite | 800.000 | | | | | |
| surface | surface | surface | | | | | | | |
| S1 | First lens L1 | Aspherical | −1.237 | 0.310 | Plastic | 1.635 | 20.373 | −2.094 | 1.464 |
| | | surface | | | | | | | |
| S2 | | Aspherical | −19.311 | 0.503 | | | | | 0.802 |
| | | surface | | | | | | | |
| STO | Aperture | Spherical | Infinite | 0.111 | | | | | 0.559 |
| | stop | surface | | | | | | | |
| S3 | Second lens | Aspherical | −4.523 | 0.326 | Plastic | 1.644 | 19.243 | −6.032 | 0.584 |
| | L2 | surface | | | | | | | |
| S4 | | Aspherical | 28.191 | 0.080 | | | | | 0.753 |
| | | surface | | | | | | | |
| S5 | Third lens | Aspherical | 1.331 | 0.993 | Plastic | 1.644 | 19.243 | 2.992 | 1.019 |
| | L3 | surface | | | | | | | |
| S6 | | Aspherical | 3.049 | 0.090 | | | | | 1.100 |
| | | surface | | | | | | | |
| S7 | Fourth lens | Aspherical | 0.495 | 0.393 | Plastic | 1.644 | 19.243 | 0.999 | 1.277 |
| | L4 | surface | | | | | | | |
| S8 | | Aspherical | 1.478 | 0.521 | | | | | 1.306 |
| | | surface | | | | | | | |
| S13 | IR | Spherical | Infinite | 0.210 | Glass | 1.508 | 64.166 | | |
| | | surface | | | | | | | |
| S14 | | Spherical | Infinite | 0.243 | | | | | |
| | | surface | | | | | | | |
| IMG | Imaging | Spherical | Infinite | 0.020 | | | | | |
| | plane | surface | | | | | | | |

Reference wavelength is 940 nm

Table 14 shows high-order coefficients applicable to the respective aspherical surfaces in the seventh embodiment. The surface shape of each aspherical surface may be defined by the formula given in the first embodiment.

TABLE 14
Seventh Embodiment
Aspherical Coefficient

| Surface | | | | | | | | |
|---|---|---|---|---|---|---|---|---|
| sequence | | | | | | | | |
| number | S1 | S2 | S3 | S4 | S5 | S6 | S7 | S8 |
| k | −3.8996E−01 | 9.9000E+01 | 4.4779E+01 | 7.5397E+01 | −7.4308E−01 | −5.1418E+00 | −4.7065E+00 | −1.1012E+00 |
| A4 | 1.4174E+00 | 1.7269E+00 | 7.8079E−01 | −1.3066E+00 | −1.0804E+00 | −3.4955E+00 | 6.4700E−01 | 6.2247E−01 |
| A6 | −2.9923E+00 | −1.7934E+01 | −4.4456E+01 | 4.7693E+00 | 5.1582E+00 | 1.7716E+01 | −3.2242E+00 | 2.3857E+00 |
| A8 | 4.6410E+00 | 2.0936E+02 | 1.0074E+03 | −1.1482E+01 | −2.2435E+01 | −7.0443E+01 | 1.5435E+01 | −4.5772E+01 |
| A10 | −2.9318E+00 | −1.3206E+03 | −1.2579E+04 | 3.4708E+00 | 7.4225E+01 | 2.0466E+02 | −5.5912E+01 | 2.7512E+02 |
| A12 | −3.7872E+00 | 4.8862E+03 | 9.1280E+04 | 4.2415E+01 | −1.8126E+02 | −4.2492E+02 | 1.3423E+02 | −9.9761E+02 |
| A14 | 1.0677E+01 | −1.1005E+04 | −3.9391E+05 | −8.1013E+01 | 3.1982E+02 | 6.2450E+02 | −2.1483E+02 | 2.4458E+03 |
| A16 | −1.1501E+01 | 1.4914E+04 | 9.9462E+05 | 4.6224E+01 | −3.9776E+02 | −6.4165E+02 | 2.2864E+02 | −4.2393E+03 |
| A18 | 7.0433E+00 | −1.1178E+04 | −1.3551E+06 | 0.0000E+00 | 3.3707E+02 | 4.4924E+02 | −1.5885E+02 | 5.2940E+03 |
| A20 | −2.5573E+00 | 3.5495E+03 | 7.6836E+05 | 0.0000E+00 | −1.8409E+02 | −2.0358E+02 | 6.8986E+01 | −4.7792E+03 |
| A22 | 5.1382E−01 | 0.0000E+00 | 0.0000E+00 | 0.0000E+00 | 5.8171E+01 | 5.3652E+01 | −1.6969E+01 | 3.0873E+03 |
| A24 | −4.4121E−02 | 0.0000E+00 | 0.0000E+00 | 0.0000E+00 | −8.0593E+00 | −6.2177E+00 | 1.8027E+00 | −1.3899E+03 |
| A26 | 0.0000E+00 | 0.0000E+00 | 0.0000E+00 | 0.0000E+00 | 0.0000E+00 | 0.0000E+00 | 0.0000E+00 | 4.1370E+02 |
| A28 | 0.0000E+00 | 0.0000E+00 | 0.0000E+00 | 0.0000E+00 | 0.0000E+00 | 0.0000E+00 | 0.0000E+00 | −7.3099E+01 |
| A30 | 0.0000E+00 | 0.0000E+00 | 0.0000E+00 | 0.0000E+00 | 0.0000E+00 | 0.0000E+00 | 0.0000E+00 | 5.8011E+00 |

FIG. 14 shows longitudinal spherical aberration curves, astigmatism curves, and a distortion curve of the optical system in the seventh embodiment. It can be seen from the aberration diagrams in FIG. 14 that the longitudinal spherical aberration, field curvature, and distortion of the optical system are well controlled. Therefore, the optical system in the present embodiment has good imaging quality.

Table 15 shows values of various relational expressions for the optical system 10 from the first embodiment to the seventh embodiment. In Table 15, E1 may represent the first embodiment, E2 may represent the second embodiment, and so on up to E7 representing the seventh embodiment.

TABLE 15

| Expression | E1 | E2 | E3 | E4 | E5 | E6 | E7 |
|---|---|---|---|---|---|---|---|
| FNO | 1.050 | 1.050 | 0.950 | 1.150 | 1.250 | 1.050 | 0.949 |
| FOV (°) | 167.292 | 169.773 | 170.543 | 170.265 | 176.617 | 163.739 | 164.939 |
| FOV/FNO (°) | 159.326 | 161.688 | 179.519 | 148.056 | 141.294 | 156.011 | 173.784 |
| TTL/ImgH | 2.776 | 2.782 | 2.754 | 2.792 | 2.762 | 2.676 | 2.676 |
| ImgH/BL | 2.037 | 2.035 | 2.119 | 1.797 | 2.029 | 2.057 | 2.058 |
| ImgH/EPD | 1.594 | 1.758 | 1.724 | 2.027 | 2.115 | 1.717 | 1.717 |
| f1/f | −2.545 | −2.011 | −2.192 | −2.118 | −2.035 | −2.859 | −2.668 |
| \|f2\|/f | 5.119 | 5.506 | 5.829 | 37.560 | 5.579 | 6.513 | 7.685 |
| f3/f | 2.667 | 2.831 | 3.005 | 8.644 | 2.843 | 3.215 | 3.812 |
| f4/f | 1.170 | 1.305 | 1.338 | 1.340 | 1.301 | 1.260 | 1.273 |
| R1/f | −1.309 | −1.468 | −1.598 | −1.547 | −1.485 | −1.422 | −1.575 |
| \|R2\|/f | 7.465 | 10.615 | 11.734 | 11.173 | 10.725 | 7.164 | 24.600 |
| R3/f | 18.904 | 9.548 | 8.178 | 7.826 | 7.586 | 5.168 | 5.761 |
| \|R4\|/f | 2.784 | 5.737 | 7.084 | 6.074 | 6.974 | 22.844 | 35.912 |
| R5/f | 1.298 | 1.397 | 1.532 | 2.673 | 1.427 | 1.503 | 1.695 |
| R6/f | 3.471 | 3.935 | 4.750 | 4.260 | 4.175 | 3.891 | 3.885 |
| f/R7 | 1.987 | 1.816 | 1.687 | 1.682 | 1.784 | 1.715 | 1.587 |
| R8/f | 1.047 | 1.134 | 1.334 | 1.362 | 1.200 | 1.494 | 1.882 |
| (R6 − R5)/f3 | 0.815 | 0.897 | 1.071 | 0.184 | 0.967 | 0.743 | 0.574 |
| ΣCT/ΣET | 1.396 | 1.352 | 1.466 | 1.474 | 1.487 | 1.437 | 1.502 |
| CT2/CT1 | 1.299 | 1.464 | 1.358 | 1.683 | 1.550 | 1.169 | 1.054 |
| CT3/CT2 | 3.126 | 2.740 | 2.992 | 2.143 | 2.914 | 2.837 | 3.043 |
| CT3/CT4 | 2.896 | 2.973 | 3.072 | 2.672 | 3.097 | 2.695 | 2.526 |
| CT2/CT4 | 0.926 | 1.085 | 1.027 | 1.247 | 1.063 | 0.950 | 0.830 |
| (CT3 + CT4)/ΣCT | 0.704 | 0.685 | 0.696 | 0.649 | 0.701 | 0.677 | 0.685 |
| CT3/ET3 | 2.794 | 2.957 | 2.956 | 2.968 | 2.883 | 3.066 | 3.238 |
| SR/SD8 | 0.478 | 0.437 | 0.437 | 0.381 | 0.357 | 0.445 | 0.428 |
| SD1/SD2 | 1.775 | 1.736 | 1.782 | 1.768 | 1.878 | 1.792 | 1.825 |
| SD1/ImgH | 1.056 | 1.049 | 1.069 | 1.014 | 1.042 | 1.024 | 1.031 |
| SD1/SD8 | 1.190 | 1.172 | 1.167 | 1.137 | 1.148 | 1.168 | 1.120 |
| R6/SD6 | 2.786 | 2.975 | 3.271 | 2.972 | 3.098 | 3.070 | 2.700 |

By satisfying the above formulas, the refractive power distribution can be uniform and reasonable, the aberrations can be easily corrected, and excellent image quality can be achieved. The optical system 10 provided by the above embodiments can meet the characteristics of a large aperture and a wide field of view. This optical system 10, while ensuring a compact and stable structure, guarantees that the optical system 10 can provide sufficient light intake and high-resolution imaging effects.

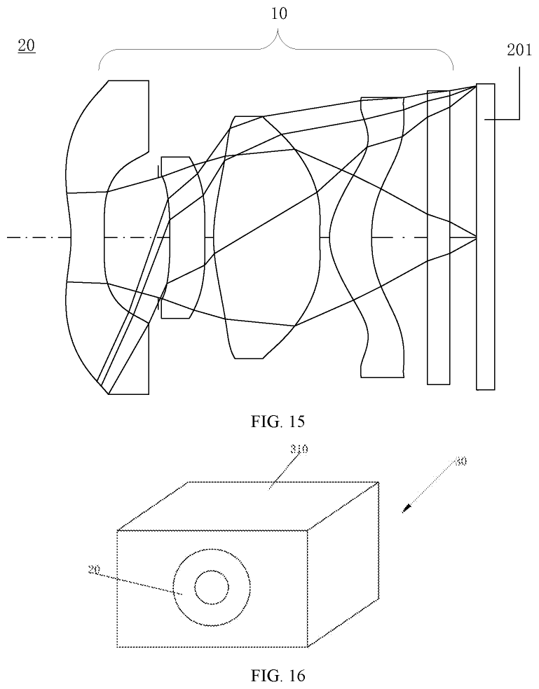

Referring to FIG. 15, a lens module 20 is further provided in an embodiment of the present disclosure. The lens module 20 includes the optical system 10 in any one of the preceding embodiments and a photosensitive chip 201. The photosensitive chip 201 is disposed at the image side of the optical system 10, and the photosensitive chip 201 and the optical system 10 may be fixed via a bracket. The photosensitive chip 201 may be a Charge Coupled Device (CCD) sensor or a Complementary Metal Oxide Semiconductor (CMOS) sensor. Generally, during assembly, the imaging plane IMG of the optical system 10 may overlap with a photosensitive surface of the photosensitive chip 201. By employing the optical system 10 described above, the lens module 20 can achieve a large aperture and a wide field of view while also ensuring that the lens module 20 maintains the characteristics of compact and stable structure and miniaturization.

Referring to FIG. 16, an electronic device 30 is further provided in an embodiment of the present disclosure. The electronic device 30 includes a housing 310 and the lens module 20 in the above embodiments, and the lens module 20 is mounted in the housing 310. The electronic device 30 may be, but not be limited to, a vehicle camera, virtual reality (VR) glasses, a smart phone, a smart watch, an e-book reader, a tablet computer, a biometric device (such as a fingerprint recognition device or a pupil recognition device), a personal digital assistant (PDA), or the like. Since the lens module 20 described above can achieve the characteristics of a large aperture and clear imaging, when the lens module 20 is adopted, the electronic device 30 can satisfy the requirements for a large aperture and a wide field of view while ensuring the miniaturization of the lens module 20, thereby reserving space for other components in the electronic device.

The above disclosure is merely illustrative of some preferred embodiments of the present disclosure, and are not intended to limit the scope of the present disclosure. Those skilled in the art can understand the entire or partial processes for implementing the above embodiments and any equivalent modifications made according to the claims of the present disclosure still fall within the scope of the present disclosure.

1. An optical system, comprising four lenses each having a refractive power, the four lenses comprise, in order from an object side to an image side along an optical axis of the optical system, a first lens, a second lens, a third lens, and a fourth lens, wherein
the first lens has a negative refractive power, an object-side surface of the first lens is configured as a concave surface proximal to a circumference of the first lens, and an image-side surface of the first lens is configured as a convex surface proximal to the circumference of the first lens;
the second lens has a refractive power;
the third lens has a positive refractive power, an object-side surface of the third lens is configured as a convex surface proximal to the optical axis, and an image-side surface of the third lens is configured as a concave surface proximal to the optical axis;
the fourth lens has a positive refractive power, an object-side surface of the fourth lens is configured as a convex surface proximal to the optical axis, and an image-side surface of the fourth lens is configured as a concave surface proximal to the optical axis; and
the optical system satisfies the following relational expressions: 0.9<FNO<1.3, and 160°<FOV<177°, wherein FNO represents an F-number of the optical system, and FOV represents a maximum field of view of the optical system.

2. The optical system of claim 1, wherein the optical system satisfies the following relational expression: 140°<FOV/FNO<180°.

3. The optical system of claim 1, wherein the optical system satisfies the following relational expression: 2.6<TTL/ImgH<2.8, wherein TTL represents a distance from the object-side surface of the first lens to an imaging plane on the optical axis, ImgH represents a half of an image height corresponding to the maximum field of view of the optical system.

4. The optical system of claim 1, wherein the optical system satisfies either or both of the following relational expressions: 1.7<ImgH/BL<2.2, and 1.5<ImgH/EPD<2.2, wherein ImgH represents a half of an image height corresponding to the maximum field of view of the optical system, BL represents a minimum distance from the image-side surface of the fourth lens to the imaging plane, and EPD represents an entrance pupil diameter of the optical system.

5. The optical system of claim 1, wherein the optical system satisfies at least one of the following relational expressions:−2.9<f1/f<−2, 5<|f2|/f<40, 2.5<f3/f<9, or, 1.1<f4/f<1.4, wherein f represents an effective focal length of the optical system, f1 represents an effective focal length of the first lens, f2 represents an effective focal length of the second lens, f3 represents an effective focal length of the third lens, and f4 represents an effective focal length of the fourth lens.

6. The optical system of claim 1, wherein the optical system satisfies at least one of the following relational expressions:−1.7<R1/f<−1.2, 6<|R2|/f<28, 5<|R3|/f<20, 2.7<R4|/f<40, 1.2<R5/f<2.8, 3.2<R6/f<5, 1.5<f/R7<2, or, 1<R8/f<2, wherein f represents an effective focal length of the optical system, R1 represents a radius of curvature of the object-side surface of the first lens at the optical axis, R2 represents a radius of curvature of the image-side surface of the first lens at the optical axis, R3 represents a radius of curvature of an object-side surface of the second lens at the optical axis, R4 represents a radius of curvature of an image-side surface of the second lens at the optical axis, R5 represents a radius of curvature of the object-side surface of the third lens at the optical axis, R6 represents a radius of curvature of the image-side surface of the third lens at the optical axis, R7 represents a radius of curvature of the object-side surface of the fourth lens at the optical axis, and R8 represents a radius of curvature of the image-side surface of the fourth lens at the optical axis.

7. The optical system of claim 1, wherein the optical system satisfies the following relational expression: 0.18<(R6−R5)/f3<1.1, wherein R5 represents a radius of curvature of the object-side surface of the third lens at the optical axis, R6 represents a radius of curvature of the image-side surface of the third lens at the optical axis, and f3 represents an effective focal length of the third lens.

8. The optical system of claim 1, wherein the optical system satisfies at least one of the following relational expressions: 1.3<ΣCT/ΣET<1.6, 1<CT2/CT1<1.7, 2.1<CT3/CT2<3.2, 2.5<CT3/CT4<3.1, 0.8<CT2/CT4<1.3, 0.6<(CT3+CT4)/ΣCT<0.71, 2.7<CT3/ET3<3.3, wherein ECT represents a sum of center thicknesses of the first lens to the fourth lens at the optical axis, ΣET represents a sum of air gaps between the first lens and the fourth lens at the optical axis, CT1 represents a center thickness of the first lens at the optical axis, CT2 represents a center thickness of the second lens at the optical axis, CT3 represents a center thickness of the third lens at the optical axis, CT4 represents a center thickness of the fourth lens at the optical axis, and ET3 represents an edge thickness of the third lens at a peripheral region of the third lens.

9. The optical system of claim 1, wherein the optical system satisfies at least one of the following relational expressions: 0.3<SR/SD8<0.5, 1.7<SD1/SD2<1.9, 1<SD1/ImgH<1.1, 1.1<SD1/SD8<1.2, or, 2.7<R6/SD6<3.3, wherein SR represents an effective semi-diameter of an aperture stop in the optical system, SD8 represents an effective semi-diameter of the image-side surface of the fourth lens, SD1 represents an effective semi-diameter of the object-side surface of the first lens, SD2 represents an effective semi-diameter of the image-side surface of the first lens, ImgH represents a half of an image height corresponding to the maximum field of view of the optical system, R6 represents a radius of curvature of the image-side surface of the third lens at the optical axis, and SD6 represents an effective semi-diameter of the image-side surface of the third lens.

10. A lens module, comprising the optical system of claim 1 and a photosensitive chip, wherein the photosensitive chip is disposed at the image side of the optical system.

11. The lens module of claim 10, wherein the optical system satisfies the following relational expression: 140°<FOV/FNO<180°.

12. The lens module of claim 10, wherein the optical system satisfies at least one of the following relational expressions: 2.6<TTL/ImgH<2.8, 1.7<ImgH/BL<2.2, or, 1.5<ImgH/EPD<2.2, wherein TTL represents a distance from the object-side surface of the first lens to an imaging plane on the optical axis, ImgH represents a half of an image height corresponding to the maximum field of view of the optical system, BL represents a minimum distance from the image-side surface of the fourth lens to the imaging plane, and EPD represents an entrance pupil diameter of the optical system.

13. The lens module of claim 10, wherein the optical system satisfies at least one of the following relational expressions:−2.9<f1/f<−2, 5<|f2|/f<40, 2.5<f3/f<9, or, 1.1<f4/f<1.4, wherein f represents an effective focal length of the optical system, f1 represents an effective focal length of the first lens, f2 represents an effective focal length of the second lens, f3 represents an effective focal length of the third lens, and f4 represents an effective focal length of the fourth lens.

14. The lens module of claim 10, wherein the optical system satisfies at least one of the following relational expressions:−1.7<R1/f<−1.2, 6<|R2|/f<28, 5<|R3|/f<20, 2.7<R4|/f<40, 1.2<R5/f<2.8, 3.2<R6/f<5, 1.5<f/R7<2, or, 1<R8/f<2, wherein f represents an effective focal length of the optical system, R1 represents a radius of curvature of the object-side surface of the first lens at the optical axis, R2 represents a radius of curvature of the image-side surface of the first lens at the optical axis, R3 represents a radius of curvature of an object-side surface of the second lens at the optical axis, R4 represents a radius of curvature of an image-side surface of the second lens at the optical axis, R5 represents a radius of curvature of the object-side surface of the third lens at the optical axis, R6 represents a radius of curvature of the image-side surface of the third lens at the optical axis, R7 represents a radius of curvature of the object-side surface of the fourth lens at the optical axis, and R8 represents a radius of curvature of the image-side surface of the fourth lens at the optical axis.

15. The lens module of claim 10, wherein the optical system satisfies the following relational expression: 0.18<(R6−R5)/f3<1.1, wherein R5 represents a radius of curvature of the object-side surface of the third lens at the optical axis, R6 represents a radius of curvature of the image-side surface of the third lens at the optical axis, and f3 represents an effective focal length of the third lens.

16. The lens module of claim 10, wherein the optical system satisfies at least one of the following relational expressions: 1.3<ΣCT/ΣET<1.6, 1<CT2/CT1<1.7, 2.1<CT3/CT2<3.2, 2.5<CT3/CT4<3.1, 0.8<CT2/CT4<1.3, 0.6<(CT3+CT4)/ΣCT<0.71, 2.7<CT3/ET3<3.3, wherein ECT represents a sum of center thicknesses of the first lens to the fourth lens at the optical axis, ΣET represents a sum of air gaps between the first lens and the fourth lens at the optical axis, CT1 represents a center thickness of the first lens at the optical axis, CT2 represents a center thickness of the second lens at the optical axis, CT3 represents a center thickness of the third lens at the optical axis, CT4 represents a center thickness of the fourth lens at the optical axis, and ET3 represents an edge thickness of the third lens at a peripheral region of the third lens.

17. The lens module of claim 10, wherein the optical system satisfies at least one of the following relational expressions: 0.3<SR/SD8<0.5, 1.7<SD1/SD2<1.9, 1<SD1/ImgH<1.1, 1.1<SD1/SD8<1.2, or, 2.7<R6/SD6<3.3, wherein SR represents an effective semi-diameter of an aperture stop in the optical system, SD8 represents an effective semi-diameter of the image-side surface of the fourth lens, SD1 represents an effective semi-diameter of the object-side surface of the first lens, SD2 represents an effective semi-diameter of the image-side surface of the first lens, ImgH represents a half of an image height corresponding to the maximum field of view of the optical system, R6 represents a radius of curvature of the image-side surface of the third lens at the optical axis, and SD6 represents an effective semi-diameter of the image-side surface of the third lens.

18. An electronic device, comprising a housing and the lens module of claim 10, wherein the lens module is disposed in the housing.

19. An optical system, comprising four lenses each having a refractive power, the four lenses comprise, in order from an object side to an image side along an optical axis of the optical system, a first lens, a second lens, a third lens, and a fourth lens, wherein
the first lens has a negative refractive power, an object-side surface of the first lens is configured as a concave surface proximal to a circumference of the first lens, and an image-side surface of the first lens is configured as a convex surface proximal to the circumference of the first lens;
the second lens has a refractive power;
the third lens has a positive refractive power, an object-side surface of the third lens is configured as a convex surface proximal to the optical axis, and an image-side surface of the third lens is configured as a concave surface proximal to the optical axis;
the fourth lens has a positive refractive power, an object-side surface of the fourth lens is configured as a convex surface proximal to the optical axis, and an image-side surface of the fourth lens is configured as a concave surface proximal to the optical axis; and
the optical system satisfies the following relational expressions: 160°<FOV<177°, and 1.5<ImgH/EPD<2.2, wherein FOV represents a maximum field of view of the optical system, ImgH represents a half of an image height corresponding to a maximum field of view of the optical system, and EPD represents an entrance pupil diameter of the optical system.

20. An optical system, comprising four lenses each having a refractive power, the four lenses comprise, in order from an object side to an image side along an optical axis of the optical system, a first lens, a second lens, a third lens, and a fourth lens, wherein
the first lens has a negative refractive power, an object-side surface of the first lens is configured as a concave surface proximal to a circumference of the first lens, and an image-side surface of the first lens is configured as a convex surface proximal to the circumference of the first lens;
the second lens has a refractive power;
the third lens has a positive refractive power, an object-side surface of the third lens is configured as a convex surface proximal to the optical axis, and an image-side surface of the third lens is configured as a concave surface proximal to the optical axis;
the fourth lens has a positive refractive power, an object-side surface of the fourth lens is configured as a convex surface proximal to the optical axis, and an image-side surface of the fourth lens is configured as a concave surface proximal to the optical axis; and
the optical system satisfies the following relational expressions: 0.9<FNO<1.3, and 140°<FOV/FNO<180°, wherein FNO represents an F-number of the optical system, and FOV represents a maximum field of view of the optical system.

21-40. (canceled)
